(19) United States
(12) Patent Application Publication
(10) Pub. No.: US 2024/0419977 A1
(43) Pub. Date: Dec. 19, 2024

(54) SYSTEMS AND METHODS FOR TRAINING AN AUTONOMOUS MACHINE TO PERFORM AN OPERATION

(71) Applicants: Naver Corporation, Gyeonggi-do (KR); Naver Labs Corporation, Gyeonggi-do (KR)

(72) Inventors: Julien Perez, Grenoble (FR); Denys Proux, Vif (FR); Claude Roux, Vif (FR); Michaël Niemaz, Saint Pierre d'Allevard (FR)

(73) Assignees: Naver Corporation, Gyeonggi-do (KR); Naver Labs Corporation, Gyeonggi-do (KR)

(21) Appl. No.: 18/640,709

(22) Filed: Apr. 19, 2024

Related U.S. Application Data
(60) Provisional application No. 63/521,763, filed on Jun. 19, 2023.

(51) Int. Cl. G06N 3/09; G06F 8/30

(52) U.S. Cl. CPC G06N 3/09; G06F 8/311

(57) ABSTRACT

Computer-implemented methods are included for training an autonomous machine to perform a target operation in a target environment. The methods include receiving a natural language description of the target operation and a natural language description of the target environment. The methods further include generating a prompt such as a reward and/or goal position signature by combining the natural language description of a target task or goal and the natural language description of the target environment. The methods then generate a reward or goal position function by prompting a large language model with the generated prompt. The methods further include computing a state description using a model of the target environment, and training a policy for the autonomous machine to perform the target task or goal using the generated function and state description.

### CROSS-REFERENCE OF RELATED APPLICATIONS

This application claims priority to U.S. Provisional Patent Application No. 63/521,763, filed on Jun. 19, 2023, titled “SYSTEMS AND METHODS FOR TRAINING AN AUTONOMOUS MACHINE TO PERFORM AN OPERATION” which is incorporated by reference in its entirety for all purposes.

### FIELD

The present disclosure relates to machine learning and more particularly to systems and methods for using machine learning to train an autonomous machine (e.g., a robot) to perform an operation (e.g., a task or a goal).

### BACKGROUND

In the context of robotic manipulation, decision models are evolving from optimal control approaches towards policy learning through Multi-task Reinforcement Learning and Goal-Conditioned Reinforcement Learning (see, W. Huang, “Inner monologue: Embodied reasoning through planning with language models, 10.48550/ARXIV.2207.05608, 2022, which is incorporated herein by reference in its entirety for all purposes). Multi-modal task definition, associated with reasoning and action planning abilities facilitated by Large Language Models (LLMs), enables agents to adapt to real-world uncertainty. Several strategies, such as behavioral cloning, transfer learning, and interactive learning, have been proposed. Scaling these approaches requires human demonstrations or handcrafted trajectories, but connecting textual descriptions of tasks with their associated computational goals and reward functions creates unscalable solutions. There exists therefore the need for more efficient methods for aligning textual descriptions with associated computational goals and reward functions to enable the scaling of method for policy learning.

### SUMMARY

Computer-implemented methods are included for training an autonomous machine to perform a target operation in a target environment. The methods include receiving a natural language description of the target operation and a natural language description of the target environment. The methods further include generating a prompt such as a reward and/or goal position signature by combining the natural language description of a target task or target goal and the natural language description of the target environment. The methods then generate a reward or goal position function by prompting a large language model with the generated prompt. The methods further include computing a state description using a model of the target environment and training a policy for the autonomous machine to perform the target task or goal using the generated function and state description.

In one embodiment, a computer-implemented method is provided for training an autonomous machine to perform a target task in a target environment. The method includes receiving a natural language description of the target task and a natural language description of the target environment. The method generates a prompt for a large language model at least in part by combining the natural language description of the target task and the natural language description of the target environment. The prompt requests executable source code to use for training a policy for the autonomous machine to perform the target task. The method then generates a function by prompting the large language model with the prompt. Based on the prompt, the function comprises executable source code that provides a reward based on whether a goal position was reached in the target environment. The method further includes computing a state description using a model of the target environment. The state description comprises a position of the autonomous machine relative to the target environment. A policy is then trained for the autonomous machine to perform the target task using the function and the state description.

In one further embodiment, the target environment includes an object other than the autonomous machine. The prompt includes a description of the object. The goal position is a target three-dimensional position of the object, and the state description further includes a current three-dimensional position of the object.

In another further embodiment, the prompt includes a function definition with parameters, a docstring describing functionality of the parameters of the function, and a request to extend the function with a body implementation of the function.

In another further embodiment, the method further includes validating the function at least in part by prompting a large language model for tests to validate the function. In a further embodiment, the method further includes correcting the function when said validating identifies an issue at least in part by prompting a large language model for a correction, wherein prompting the large language model for the correction includes providing, to the large language model, the function and information about the issue.

In another further embodiment, the prompt includes one or more examples of one or more valid functions for one or more tasks other than the target task, wherein the one or more examples are provided in source code form. In a further embodiment, the method includes searching an existing code repository to find the one or more examples based at least in part on the natural language description of the target task. Different examples are used to generate different functions for at least two different target tasks including said target task.

In another further embodiment, the prompt is a second prompt, and the method further includes generating a first prompt for a large language model at least in part by combining the natural language description of the target task and the natural language description of the target environment. The first prompt requests one or more goal positions to use in training the policy for the autonomous machine to perform the target task. The method then generates the goal position by prompting a large language model with the first prompt. The second prompt references the goal position.

In another further embodiment, the prompt includes an example of a task-independent portion of another function. The task-independent portion of the other function is stored in a repository with other task-independent portions of a plurality of functions and selected based at least in part on the natural language description of the target task and one or more characteristics of the task-independent portion. The prompt requests that the large language model include an explicit reference to the task-independent portion of the other function in the function.

In another further embodiment, the prompt includes an example of a task-dependent portion of another function. The task-dependent portion of the other function is stored in a repository with other task-dependent portions of a plurality of functions and selected based at least in part on the natural language description of the target task and one or more characteristics of the task-dependent portion. The prompt requests that the large language model use the task-dependent portion as an example without including, in the function to be generated based on the prompt, the task-dependent portion of the other function and without including, in the function to be generated based on the prompt, a reference to the task-dependent portion of the other function.

In accordance with one embodiment, a computer-implemented method for training an autonomous machine to perform a target task in a target environment, includes: (i) receiving a natural language description of the target task and a natural language description of the target environment; (ii) generating a reward signature by combining the natural language description of the target task and the natural language description of the target environment; (iii) generating a reward function by prompting a large language model with the reward signature; (iv) computing a state description using a model of the target environment and an embedding of the natural language task description; and (v) training a policy for the autonomous machine to perform the target task using the reward function and the state description.

In accordance with another embodiment, a computer-implemented method for training an autonomous machine to perform a target goal in a target environment, includes: (i) receiving a natural language description of the target goal, a natural language description of the target environment, and a reward function defined according to the target environment; (ii) generating a goal position signature by combining the natural language description of the target goal and the natural language description of the target environment; (iii) generating a goal position function by prompting a large language model with the goal position signature; (iv) computing a state description using a model of the target environment and a goal position derived from the goal position function; and (v) training a policy for the autonomous machine to reach the target goal using the goal position derived from the goal position function, the state description, and the reward function.

The described techniques may be implemented as methods performed by a machine, as machine(s) or system(s) including memory, one or more processors, and one or more non-transitory computer-readable media storing instructions, which, when executed, cause performance of steps of the methods, and/or as one or more non-transitory computer-readable media storing processor-executable instructions which, when executed, cause one or more processors to perform steps of the methods.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates an example of a system architecture in which the methods according to the present disclosure may be performed;

FIG. 2 is a functional block diagram of an example control system of an autonomous machine;

FIG. 3 is a functional block diagram of a training module for training a policy for performing a task of an autonomous machine;

FIG. 4 is a flow diagram of a method for training a policy for performing a task using the task training module shown in FIG. 3;

FIG. 5 illustrates elements of an example python function;

FIG. 6 illustrates an example reward signature generated by the task training module shown in FIG. 3;

FIG. 7 illustrates an example reward function output by a large language module prompted using the reward signature generated in accordance with the present disclosure;

FIG. 8A illustrates a flow diagram of a method for carrying out function testing and exception handling;

FIG. 8B illustrates an example prompt for generating a functional test using a Large Language Model (LLM);

FIG. 8C illustrates an example functional test generated by an LLM using the prompt shown in FIG. 8B;

FIG. 8D illustrates an example prompt for generating a revised reward function to correct runtime errors using an LLM;

FIG. 9 illustrates a functional block diagram for using the policy trained using the task training module in FIG. 3 during inference;

FIG. 10 is a functional block diagram of the training module for training a policy for performing a goal of the autonomous machine;

FIG. 11 is a flow diagram of a method for training a policy for performing a goal using the goal training module;

FIG. 12 illustrates an example goal position function generated by an LLM from an example goal position signature;

FIG. 13 illustrates a functional block diagram for using the policy trained using the goal training module shown in FIG. 10 during inference;

FIGS. 14A-14B shows example results produced by prompts for determining goal poses generated for manipulation tasks;

FIG. 15 shows example success rates for an example set of manipulation tasks;

FIG. 16 shows example success rates obtained for example tasks used for automatic reward generation;

FIG. 17 shows an example system for transforming a textual task description into either a goal to be used as input of a given reward function, or a reward function;

FIG. 18 shows an example search and retrieval pipeline for gathering code examples;

FIGS. 19A-B show an example prompt including example code to provide the LLM with additional context in generating a result;

FIG. 20 shows an example prompt coordinator gathering inputs to generate a prompt that causes an LLM to produce goal positions and/or a reward function; and

FIG. 21 shows an example process for generating a prompt that causes an LLM to generate content for use in training a policy of an autonomous machine.

In the drawings, reference numbers may be reused to identify similar and/or identical elements.

### DETAILED DESCRIPTION

### 1. System Architecture

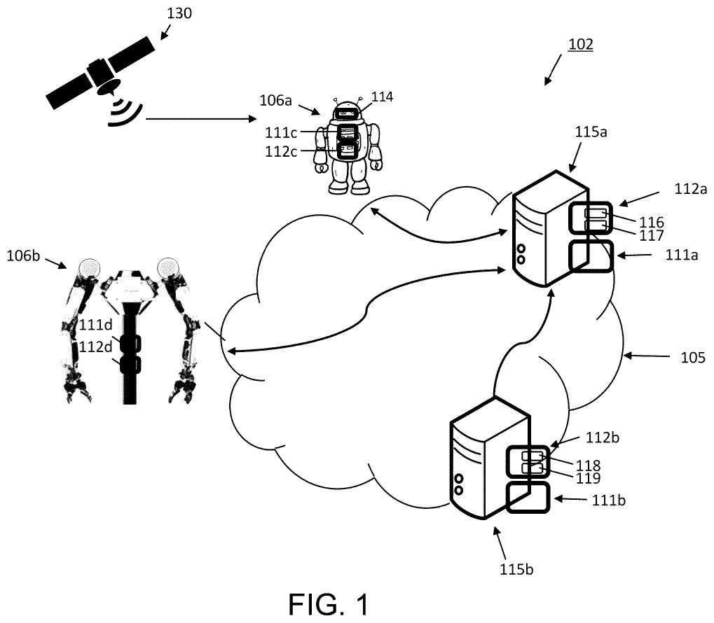

Methods for automatically training policies for an autonomous machine to perform an operation (e.g., a task or goal) using lang Language-based Automatic Reward and Goal Generation (LARG²) disclosed hereunder may be implemented within a system 102 architected as illustrated in FIG. 1, which comprises one or more servers 115 and one or more autonomous machines 106, such as autonomous robot 106a (e.g., the mini Cheetah robot or the Around robot by Naver) or autonomous arms 106b (e.g., AMBIDEX by Naver or the Panda Robotic Arm by Franka Emika), which include one or more processors 111 (e.g. 111a, 111b, 111c, and 111d) and memory 112 (e.g. 112a, 112b, 112c, and 112d) such as a hard drive. In one embodiment, autonomous robot 106a is located using positioning system 114 communicating with geo-positioning system (GPS) 130. Alternate embodiments may include autonomous vehicles with autonomous arms. The positioning system 114 may, alternatively to geo-positioning system (GPS) 130, comprise a cellular positioning system, an indoor positioning system (IPS), including beacons, RFID, WiFi and geomagnetic, or a combination thereof. Servers 115 and autonomous machines 106 may communicate over a network 105 (which may be wireless and/or wired) such as the Internet for data exchange.

In one embodiment, the server 115a (with processor 111a and memory 112a) may include a task/goal solver module 116 and a control module 117 in memory 112a containing functionality for controlling autonomous machines 106, and the server 115b may include training module 118 and dataset 119 for training the policies of the task/goal solver module 116. In alternate embodiments, the modules 116, 117, 118, and 119 may be implemented in memory 112 of the autonomous machines 106, or a combination thereof (e.g., modules 116 and 117 implemented in memory 112 of the autonomous machines 106 and modules 118 and 119 implemented in memory 112b on server 115b, having processor 111b). In another embodiment, it is noted that the two servers 115a and 115b may be merged.

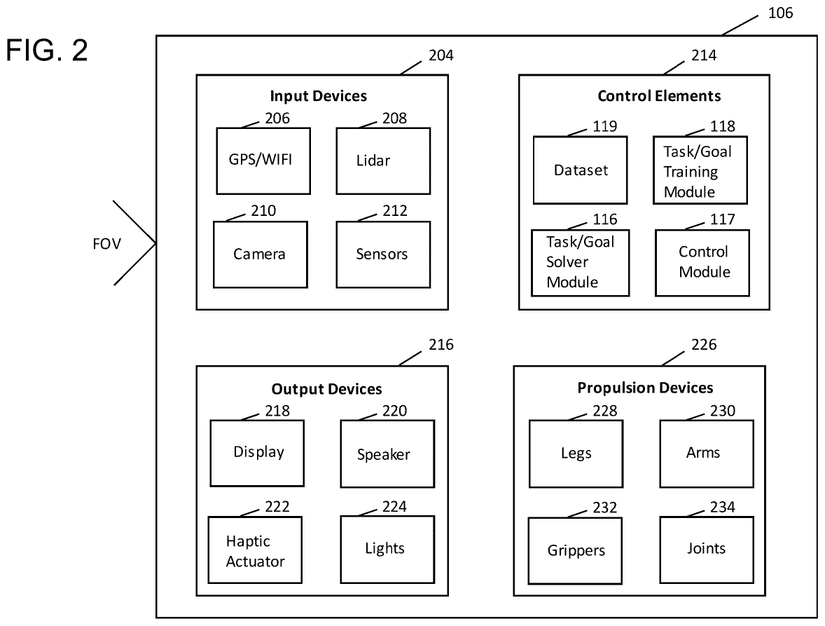

FIG. 2 is a functional block diagram of an example control system of an autonomous machine 106. The autonomous machine 106, which may be mobile or stationary and indoor or outdoor, and may include one more of the following elements: input devices 204 (e.g., GPS/WIFI 206, Lidar 208, camera 210 (which may include be grayscale, or red, green, blue (RGB) sensors for capturing images within a predetermined field of view (FOV), or which may update (capture images) at a predetermined frequency, such as 60 hertz (Hz), 120 Hz, or another suitable frequency, and which may capture depth information such as RGB-D), sensors 212 (e.g., temperature, rain, force, torque), control elements 214, output devices 216 (e.g., display 218, speakers 220, haptic actuator 222, lights 224), and propulsion devices (e.g., legs 228, arms 230, grippers 232, and joints 234). The autonomous machine 106 is powered, such as via an internal battery and/or via an external power source, such as alternating current (AC) power. AC power may be received via an outlet, a direct connection, etc. In various implementations, the autonomous machine 106 may receive power wirelessly, such as inductively. In alternate embodiments, the autonomous machine 106 may include alternate propulsion devices 226, such as one or more wheels, one or more treads/tracks, one or more propellers, and/or one or more other types of devices configured to propel the autonomous machine 106 forward, backward, right, left, up, and/or down.

In operation, the control module 117 actuates the propulsion device(s) 226 to perform tasks or goals issued by the solver module 116. In one exemplary embodiment, speaker 220 receives a natural language description of a task or goal that is input after being processed by an audio-to-text converter to solver module 116 that provides input to control module 117 to carry out the goal or task. The methods disclosed hereunder automate, for a given task or goal, the alignment of textual descriptions of tasks and goals and associated reward and goal functions to automate the training of sequential decision models using Goal-Conditioned Reinforcement Learning and Multi-Task Reinforcement Learning, respectively, using a large language model (LLM) to generate source code using the textual descriptions. In one embodiment, a policy for performing a goal is generated for a given environment of an autonomous machine (e.g., robot) using a textual description of the goal. In another embodiment, a policy for performing a task is generated for a given environment using a natural language description of the task.

In the same or a different embodiment, a function such as a goal setting function and/or a reward function are generated separately or combined for a given environment using natural language descriptions of task(s) or sub-task(s) and/or a sequence of task(s) or sub-task(s). Different ones of the goal setting function and/or the reward function may be either automatically generated by prompting an LLM with a specialized prompt or manually generated in different examples. In one example, the policy uses an automatically generated goal position based on an automatically generated goal setting function in combination with an automatically generated reward based on an automatically generated reward function. In another example, the policy uses a manually generated goal position in combination with an automatically generated reward based on an automatically generated reward function. In yet another example, the policy uses an automatically generated goal position based on an automatically generated goal setting function in combination with an automatically generated reward based on a manually generated reward function.

A task or a sequence of tasks may involve reaching one or more sub-goals represented by one or more goal positions in the environment. The LLM may set the one or more goal positions based on a natural language description of the task or sequence of tasks, and the LLM may further use the one or more goal positions to generate a reward function that evaluates whether the autonomous machine should be rewarded for progress towards a goal position. In the case of a task or a sequence of tasks that involves multiple goal positions, the goal positions may be specified with a particular order or sequence. In this case, the reward function may evaluate whether the autonomous machine should be rewarded for progress towards a next goal position in the sequence of goal positions, optionally without regard to other goal positions that have not yet been reached in the sequence.

In one embodiment, multiple goal positions are generated for a single task, each of the goal positions representing a different valid way of completing the task. Previously generated goal positions may be fed into an LLM with a prompt to generate a new goal position that also accomplishes the task, if such a new goal position is possible. These new goal positions may be continually generated for a predetermined number, or until goal positions are no longer available to be generated that are sufficiently different (e.g., beyond a threshold distance) from previously generated goal positions. The variety of different goal positions may be fed into the LLM to generate a reward function consistent with the variety of different goal positions, to reward the autonomous machine for accomplishing a goal position predicted to be closest or most reachable at any given point.

In one embodiment, a single reward function evaluates one or more positions of the autonomous machine and determines whether or not to reward the autonomous machine based on progress towards one or more goals, for example, represented by one or more goal positions. In another embodiment, a reward function may determine which phase of a sequence of tasks the autonomous machine is currently working on, and a particular reward function specific to the phase or group of one or more sub-tasks of the sequence of tasks may be used to determine whether or not to reward the autonomous machine for progress towards the one or more goals. In this manner, different reward functions specific to different groups of sub-tasks may be used in combination to determine whether to reward the autonomous machine at various phases of completion of the overall goal or task.

In various embodiments, goal positions and/or reward functions may be generated for a variety of tasks for a variety of simulated environments and used to train simulated autonomous machines to complete the variety of tasks in the variety of simulated environments. The simulated autonomous machine may be represented as a virtual actor in a software environment with virtual dimensions based on physical dimensions of the actual autonomous machine. The policies developed for the simulated autonomous machines may be used in actual autonomous machines to perform the variety of tasks in actual environments. If the autonomous machine is trained on a wide enough range of simulated environments, the policy for completing a task may be able to be performed without complete knowledge of the actual environment as long as the portions of the environment that caused policy execution to differ between the simulated environments are known. Training in such a wide range of simulated environments provides more robust execution by the autonomous machine.

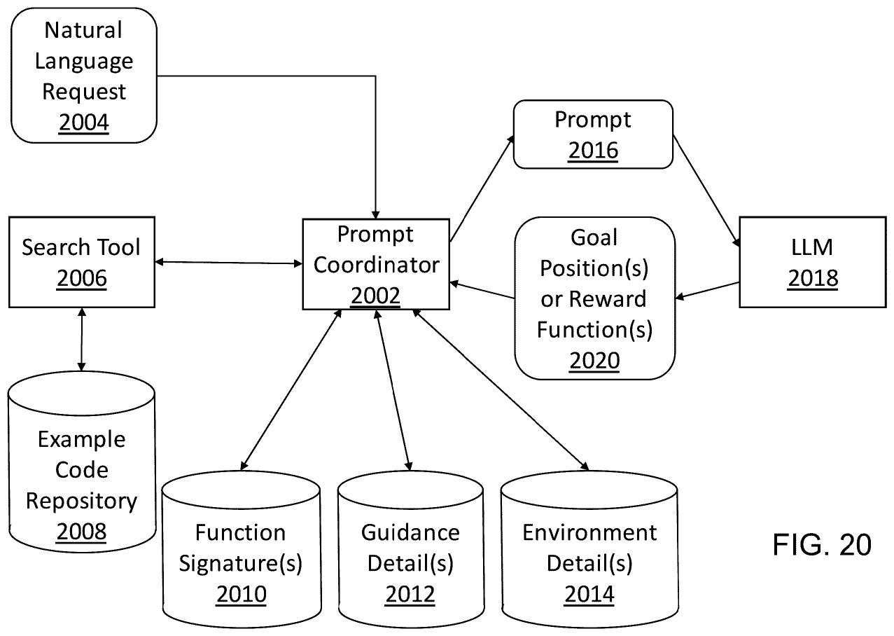

FIG. 20 shows a system for generating a prompt according to techniques described herein. Referring to FIG. 20, a prompt coordinator 2002 receives a natural language request 2004 and gathers information from sources to generate prompt 2016 to LLM 2018. LLM 2018 produces goal position(s) and/or reward function(s) based on the prompt 2016. Prompt coordinator 2002 may retrieve information from search tool 2006, which looks for code examples similar to what might be produced from natural language request 2004, in example code repository 2008. Prompt coordinator 2002 may also retrieve information about function signature(s) 2010 that may be relevant to the natural language request 2004, guidance detail(s) 2012 that may be relevant to natural language request 2004, and/or environment detail(s) 2014 that may be relevant to natural language request 2004. In gathering the information to generate and include in prompt 2016, prompt coordinator 2002 may analyze natural language request 2004 to determine a category of the request, a type of task involved, a name of the environment referenced, and/or any other characteristic of the request 2004 that aids in selecting relevant information for inclusion in prompt 2016. The selected information may have been similarly classified, categorized, tagged with environment information, task information, or other characteristics that can be matched with the request 2004.

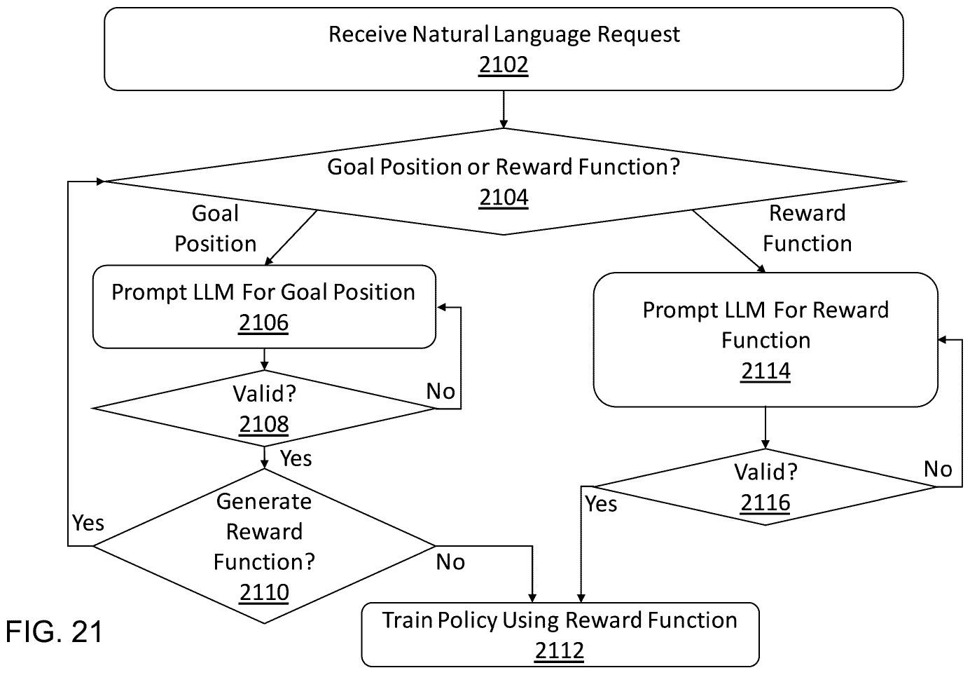

FIG. 21 shows a process for generating content to train an autonomous machine according to techniques described herein. Referring to FIG. 21, a natural language request is received at block 2102. A determination is made in block 2104 as to whether a goal position or reward function is requested. If a goal position is requested, processing proceeds to block 2106, where an LLM is prompted for the goal position. If the goal position is valid, determined in block 2108, a further determination is made in block 2110 as to whether a reward function is to be automatically generated using the goal position. If the goal position is not valid, processing proceeds back to block 2106, prompting the LLM for a goal position, this time with information about the previously invalid goal position.

If the goal position is valid and a reward function is to be automatically generated, processing proceeds to block 2114, where an LLM is prompted for a reward function. Block 2114 may proceed from block 2104 after receiving the natural language request, or from block 2110, using the generated goal position as input. A determination is made as to whether the resulting reward function is valid in block 2116. If the reward function is valid, a policy is trained using the reward function in block 2112. If the automatically generated reward function is invalid, processing returns to block 2114 to prompt the LLM for a new reward function, this time using information about the error determined in block 2116 as input. Training the policy in block 2112 may also be reached using the automatically generated goal position from block 2106 and an existing reward function to train the policy.

### 2. Reinforcement Learning in the Context of Reward and Goal Generation

Reinforcement Learning considers an agent which performs sequences of actions in a given environment to maximize a cumulative sum of rewards. Such problem is commonly framed as Markov Decision Processes (MDPs): M={S, A, T, ρ₀, R}, where S is the state description (or the environment and the position of the robot relative to the environment), A is the action space (the actions to be taken by components of robot), T are transition probabilities (or the policy), ρ is a discount factor, and R is the reward function. The agent and its environment, as well as their interaction dynamics, are defined by the first components S, A, T, ρ₀, where s∈S describes the current state of the agent-environment interaction and ρ₀ is the distribution over initial states. The agent interacts with the environment through actions a∈A. The transition function T models the distribution of the next state sₜ₊₁ conditioned with the current state and action T:p(sₜ₊₁|sₜ, aₜ). Then, the objective of the agent is defined by the remaining component of the MDP, R:S→R. Solving a Markov decision process consists in finding a policy π:S→A that maximizes the cumulative sum of discounted rewards accumulated through experiences.

Further background on framing Reinforcement Learning using Markov Decision Processes is set forth in the following publications, each of which is incorporated herein by reference in its entirety for all purposes: (i) R. S. Sutton and A. G. Barto, “Reinforcement learning: An introduction”, IEEE Transactions on Neural Networks, 16:285-286, 2005; (ii) V. Mnih, A. P. Badia, M. Mirza, A. Graves, T. P. Lillicrap, T. Harley, D. Silver, and K. Kavukcuoglu, “Asynchronous methods for deep reinforcement learning”, in ICML, 2016; and (iii) T. P. Lillicrap, J. J. Hunt, A. Pritzel, N. M. O. Heess, T. Erez, Y. Tassa, D. Silver, and D. Wierstra, “Continuous control with deep reinforcement learning”, CoRR, abs/1509.02971, 2016.

In a discussion of Reinforcement Learning using Markov Decision Processes, Mnih et al., “Asynchronous methods for deep reinforcement learning,” states: “[C]onsider the standard reinforcement learning setting where an agent interacts with an environment ε over a number of discrete time steps. At each time step t, the agent receives a state sₜ and selects an action aₜ from some set of possible actions [symbol] according to its policy π, where π is a mapping from states sₜ to actions aₜ. In return, the agent receives the next state sₜ₊₁ and receives a scalar reward rₜ. The process continues until the agent reaches a terminal state after which the process restarts. The return Rₜ=Σₖ₌₀^{∞}γ^{k}rₜ₊ₖ is the total accumulated return from time step t with discount factor y∈(0,1]. The goal of the agent is to maximize the expected return from each state sₜ.”

In another discussion of Reinforcement Learning using Markov Decision Processes, Lillicrap et al., “Continuous control with deep reinforcement learning”, CoRR, abs/1509.02971, 2016, states: “For physical control tasks [use] reward functions which provide feedback at every step. In all tasks, the reward contained a small action cost. For all tasks that have a static goal state (e.g. pendulum swingup and reaching) [p]rovide a smoothly varying reward based on distance to a goal state, and in some cases an additional positive reward when within a small radius of the target state. For grasping and manipulation tasks [use] a reward with a term which encourages movement towards the payload and a second component which encourages moving the payload to the target. In locomotion tasks [r]eward forward action and penalize hard impacts to encourage smooth rather than hopping gaits [ ]. In addition, [use] a negative reward and early termination for falls which were determined by simple thres[h]olds on the height and torso angle (in the case of walker2d).” In Lillicrap et al., “walker2d” is an example “task name” where: “Agent should move forward as quickly as possible with a bipedal walker constrained to the plane without falling down or pitching the torso too far forward or backward.”

In a discussion of Multi-task Reinforcement Learning and Goal-Conditioned Reinforcement Learning, Huang, “Inner monologue: Embodied reasoning through planning with language models, 10.48550/ARXIV.2207.05608, 2022, states: “[An]instantiation of InnerMonologue uses (i) InstructGPT[ ] as the LLM for multi-step planning[ ], (ii) scripted modules to provide language feedback in the form of object recognition (Object), success detection (Success), and task-[p]rogress scene description (Scene), and (iii) a pre-trained language-conditioned pick-and-place primitive (similar to CLIPort[ ] and Transporter Nets[ ]). Object feedback informs the LLM planner about the objects present in the scene, and the variant using only Object feedback is similar to the demonstrated example in [ ] this environment. Success feedback informs the planner about success/failure of the most recent action. However, in the presence of many objects and test-time disturbances, the complex combinatorial state space requires the planner to additionally reason about the overall task progress (e.g., if the goal is to stack multiple blocks, the unfinished tower of blocks may be knocked over by the robot). Therefore, task-progress scene description (Scene) describes the semantic sub-goals inferred by the LLM towards completing the high-level instruction that is achieved by the agent so far. For the variant that uses Object+Scene feedback, due to the additional reasoning complexity, [a]dding chain-of-thought [ ] can improve the consistency between inferred goals and achieved goals.”

In a Goal-Conditioned Reinforcement Learning (GCRL) approach, a goal consists in altering the environment into a targeted state through selective contact. In such a case, goals can be expressed as g=(c_{g}, R_{G}) pair where c_{g} is a compact goal configuration such as Cartesian coordinates and R_{G}:S×G→R is a goal-achievement function that measures progress towards goal achievement and is shared across goals. In effect in a GCRL setting, a goal-conditioned MDP may be defined as: Mg={S, A, T, ρ₀, c_{g}, R_{G}} with a reward function shared across goals (i.e., where the reward is predefined).

In Multi-Task Reinforcement Learning (MTRL) approach, an agent solves a possibly large set of tasks jointly. It is trained on a set of rewards associated with each task. Goals are defined as constraints on one or several consecutive states that the agent seeks to satisfy. In effect in an MTRL settings, each task has its own goals and reward function (i.e., the reward is conditioned by the task), where MDP is defined as: MT={S, A, T, ρ₀, R}.

Further background on GCRL and MTRL approaches is set forth in the following publications, each of which is incorporated herein by reference in its entirety for all purposes: (i) S. Gu, E. Holly, T. Lillicrap, and S. Levine, “Deep reinforcement learning for robotic manipulation with asynchronous off-policy updates”, in 2017 IEEE International Conference on Robotics and Automation (ICRA), pages 3389-3396, 2017. doi:10.1109/ICRA.2017.7989385; (ii) M. Plappert, M. Andrychowicz, A. Ray, B. McGrew, B. Baker, G. Powell, J. Schneider, J. Tobin, M. Chociej, P. Welinder, V. Kumar, and W. Zaremba, “Multi-goal reinforcement learning: Challenging robotics environments and request for research”, ArXiv, abs/1802.09464, 2018; (iii) A. Nair, V. H. Pong, M. Dalal, S. Bahl, S. Lin, and S. Levine, “Visual reinforcement learning with imagined goals” in NeurIPS, 2018; and (iv) O. OpenAI, M. Plappert, R. Sampedro, T. Xu, I. Akkaya, V. Kosaraju, P. Welinder, R. D'Sa, A. Petron, H. P. de Oliveira Pinto, A. Paino, H. Noh, L. Weng, Q. Yuan, C. Chu, and W. Zaremba, “Asymmetric self-play for automatic goal discovery in robotic manipulation”, ArXiv, abs/2101.04882, 2021.

In a discussion of reinforcement learning, Gu et al., “Deep reinforcement learning for robotic manipulation with asynchronous off-policy updates”, in 2017 IEEE International Conference on Robotics and Automation (ICRA), pages 3389-3396, 2017. doi:10.1109/ICRA.2017.7989385, states: “The goal in reinforcement learning is to control an agent attempting to maximize a reward function which, in the context of a robotic skill, denotes a user-provided definition of what the robot should try to accomplish. At state xₜ in time t, the agent chooses and executes action uₜ according to its policy π(uₜ|xₜ), transitions to a new state xₜ according to the dynamics p(xₜ|xₜ, uₜ) and receives a reward r(xₜ,uₜ). Here, we consider infinite-horizon discounted return problems, where the objective is the y-discounted future return from time t to ∞, given by Rₜ=Σᵢ₌ₜ^{∞}γ^{(i-t)}r(xᵢ, uᵢ). The goal is to find the optimal policy π* which maximizes the expected sum of returns from the initial state distribution, given by R= [symbol] _{π}[R₁].”

[symbol]

In a discussion of reinforcement learning, Plappert et al., “Multi-goal reinforcement learning: Challenging robotics environments and request for research”, ArXiv, abs/1802.09464, 2018, states: “[T]he goal is 3-dimensional and describes the desired position of the object (or the end-effector for reaching). Rewards are sparse and binary: The agent obtains a reward of 0 if the object is at the target location (within a tolerance of 5 cm) and −1 otherwise. Actions are 4-dimensional: 3 dimensions specify the desired gripper movement in Cartesian coordinates and the last dimension controls opening and closing of the gripper . . . . Observations include the Cartesian position of the gripper, its linear velocity as well as the position and linear velocity of the robot's gripper. If an object is present, we also include the object's Cartesian position and rotation using Euler angles, its linear and angular velocities, as well as its position and linear velocities relative to gripper.” Later, Plappert et al., “Multi-goal reinforcement learning: Challenging robotics environments and request for research”, ArXiv, abs/1802.09464, 2018, explains that “[G]oals . . . describe the desired outcome of a task.”

In a discussion of goal-conditioned reinforcement learning, Plappert et al., “Asymmetric self-play for automatic goal discovery in robotic manipulation”, ArXiv, abs/2101.04882, 2021, states: “[M]odel the interaction between an environment and a goal-conditioned policy as a goal-augmented Markov decision process M= [symbol] S, A, P, R, G [symbol] , where S is the state space, A is the action space, P:S×A×S [symbol] denotes the transition probability, G⊆S specifies the goal space and R:S×G [symbol] is a goal-specific reward function. A goal-augmented trajectory sequence is {(s₀, g, a₀, r₀), . . . , (sₜ, g aₜ, rₜ)}, where the goal is provided to the policy as part of the observation at every step. [S]ay a goal is achieved if sₜ is sufficiently close to g (Appendix A.2). With a slightly overloaded notation, [d]efine the goal distribution G (g/so) as the probability of a goal state g∈G conditioned on an initial state s₀∈S.” In Appendix A.2, Plappert et al., “Asymmetric self-play for automatic goal discovery in robotic manipulation”, ArXiv, abs/2101.04882, 2021, states: “If the distance and angle for all objects are less than a small error (0.04 meters and 0.2 radians respectively), [c]onsider the goal achieved.”

In various embodiments described herein, goal-conditioned reinforcement learning and/or multi-task reinforcement learning may be applied to automatically generate a function for training an autonomous machine to perform one or more tasks to achieve and be rewarded for one or more goals. The one or more tasks may be automatically converted to one or more goal positions by prompting one or more LLMs using a structured prompt. The one or more tasks may be automatically converted into an overall goal and/or sub-goals or steps to be completed to meet the overall goal. In one embodiment, a prompt to one or more LLMs is generated to request one or more goal positions representing one or more sub-goals of an overall goal. The prompt may request separate goal positions for separate sub-goals to maximize the emphasis of the LLMs on each sub-goal. The separate goal positions may need to be satisfied at the same time or sequentially, at different times.

In the same or a different embodiment, a prompt to one or more LLMs is generated to request one or more reward functions rewarding one or more sub-goals of an overall goal. The prompt may request separate reward functions for separate sub-goals to maximize the emphasis of the LLMs on rewarding each sub-goal appropriately based on progress towards the sub-goal rather than or in addition to progress towards an overall goal. The separate reward functions may be connected together with a reward function that determines which of the separate reward functions applies based on a state of the autonomous machine in accomplishing the overall goal represented by the sub-goals.

A reward function may not always reward movements that are closer to the goal position, as different tasks may require different movements towards accomplishing the task. For example, a task may require an object to be moved around another object, or over another object, before landing in a final goal position. In this scenario, the reward function may reward movements away from the goal position and/or movements toward the goal position. The reward function is designed to incentivize accomplishing the given task, with whatever incentives are predicted to lead the autonomous machine to accomplish the given task, whether those incentives depend strictly on goal positions or not.

In one embodiment, one or more goal positions are determined, via prompting the LLMs for goal positions, separately from the one or more reward functions. The one or more goal positions may then be input into the one or more reward functions for determining whether and how much to reward an autonomous machine for making progress towards a sub-goal or an overall goal. The generated reward function may then reference these goal positions as variables or constants, depending on how the goal positions are defined. This approach allows separate prompts for goal positions associated with sub-goals to provide emphasis to the LLM on precise sub-goals.

In another embodiment, one or more goal positions are determined by the one or more reward functions themselves based on one or more conditions that are hard-coded into the one or more reward functions. For example, the one or more conditions may account for relative positions of objects that collectively satisfy the task description (e.g., “arrange the objects in a triangle”), when there may be an infinite number of goal positions available to satisfy the task description. For example, the reward function may check that the objects are co-planar or not, aligned on the same line or not, forming a certain angle with respect to each other or not, etc. In these embodiments, the LLMs may be prompted for reward functions that include code based on specific goal configurations, goal conditions, or goal positions that are also generated in response to the prompt. The generated function may reference these internally defined goal positions as variables or constants, depending on how the goal positions are defined. For example, a goal position of an object defined relative to a position of another object may be defined as a variable position depending on the position of the other object. In one example, this approach is used for complex goals where goal positions of different objects depend on each other and are difficult or not possible to independently define as constant positions in a manner that covers all possible goal positions that satisfy the task description.

In one embodiment, the natural language task description requests performance of a task, and a prompt is generated to cause generation of a reward function to perform the task. In one embodiment, the reward function inherently includes references to one or more goal positions in order to determine whether or not to reward a user for nearing completion of the task. Goal positions may be specified in absolute terms relative to the environment or in relative terms relative to other objects in the environment or the autonomous machine.

In another embodiment, the reward function does not reference any goal positions to determine whether or not to reward the user for nearing completion of the task. Instead, the reward function may use characteristics such as orientation, direction, speed, velocity, acceleration, and/or other factors to determine whether the task has been accomplished or is approaching being accomplished. For example, a natural language task description may be to “move a cube slowly” or “quickly,” or to “repeatedly change directions of moving the robot's arm.” Some of these factors that are not strictly positional, such as speed, may still depend on one or more positions of the autonomous machine, but depend on those positions over time rather than in absolute terms. As such, the reward function may still include a reference to one or more goal positions, for example, depending on one or more prior goal positions, or based on one or more other goal positions at a different point in time. Code examples with complex factors may be provided to the LLM to help the LLM generate complex reward functions that are not strictly dependent on a final goal position.

In one embodiment, an autonomous machine operates according to a policy that maximizes the reward function. In the same or a different embodiment, the policy may incentivize space and functionality exploration without strictly maximizing the reward function, if maximizing the reward function does not immediately accomplish the goal or task. For example, if the autonomous machine receives a reward for moving to a region and a penalty for moving away from the region, but has not accomplished the task after thoroughly exploring the region, the autonomous machine may explore other regions to see if rewards are given in those regions, and/or may explore performing functionality with respect to one or more objects in the region. For example, the policy may attempt to grab an object, lift an object, move or push an object, rotate an object, etc., to determine if separate rewards or penalties or greater rewards or penalties are given for these experimental sub-tasks. Based on these rewards or penalties, the autonomous machine may begin to perform sub-tasks in a particular order that combines separately rewarded sub-tasks until a full reward is received indicating that the overall task is complete.

The automatically generated reward function may account for variances in policies that drive agents of autonomous machines. For example, agents may attempt to maximize a cumulative sum of rewards, where sub-tasks or movements that make progress towards a goal are rewarded, for example, based on how much progress is made, and these movements together accomplish the goal to achieve a full cumulative reward indicating that the goal was accomplished. Agents may be preconfigured to understand certain rewards as partial rewards and other rewards as full rewards, or may learn such reward schemes from the reward function. The prompt to automatically generate the reward function may include details about how the policy expects to be rewarded and/or penalized, and/or the LLM may generate the reward function with a default treatment of policies, such as policies that maximize rewards and minimize penalties.

### 3. Task Reward Functions Design

In the context of robot manipulation, a reward function must be designed for each robot task. To automate the generation of reward functions, the methods disclosed hereunder employ large language models (LLMs) to assist in such automation. LLMs are large neural networks trained on large quantities of unlabeled data. The architecture of such neural networks may be based on the transformer architecture, which is one way to implement a self-attention mechanism. Transformer architecture as used herein is described in Ashish Vaswani et al., “Attention is all you need”, In I. Guyon et al., editors, Advances in Neural Information Processing Systems 30, pages 5998-6008, Curran Associates, Inc., 2017, which is incorporated herein by reference in its entirety for all purposes. Additional information regarding the transformer architecture can be found in U.S. Pat. No. 10,452,978, which is incorporated herein by reference in its entirety for all purposes. Alternate attention-based architectures include recurrent, graph and memory-augmented neural networks.

In discussing attention-based architectures, Ashish Vaswani et al., “Attention is all you need,” states: “Self-attention, sometimes called intra-attention is an attention mechanism relating different positions of a single sequence in order to compute a representation of the sequence. Self-attention has been used successfully in a variety of tasks including reading comprehension, abstractive summarization, textual entailment, and learning task-independent sentence representations.” Ashish Vaswani et al., “Attention is all you need,” further states: “An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.” In describing the transformer architecture, Ashish Vaswani et al., “Attention is all you need,” states: “Most competitive neural sequence transduction models have an encoder-decoder structure [ ]. Here, the encoder maps an input sequence of symbol representations (xᵢ, . . . , xₙ) to a sequence of continuous representations z=(z₁, . . . , zₙ). Given z, the decoder then generates an output sequence (y₁, . . . , yₘ) of symbols one element at a time. At each step the model is auto-regressive [ ], consuming the previously generated symbols as additional input when generating the next. The Transformer follows this overall architecture using stacked self-attention and point-wise, fully connected layers for both the encoder and decoder . . . .”

In addition, in the context of robot manipulation, a sequential decision task requires defining an informative reward function to enable reinforcement learning. Reward shaping consists in designing a function in an iterative process incorporating elements from domain knowledge to guide policy search algorithms. Formally, this can be defined as R′=R+F, where F is the shaping reward function, and R′ is the modified reward function. The methods disclosed hereunder combine reward shaping with the use of LLMs to iteratively refine reward functions in an automated manner from a natural language description of a task or goal.

Further background on reward shaping is set forth in the following publications, each of which is incorporated herein by reference in its entirety for all purposes: (i) M. Dorigo and M. Colombetti. “Robot shaping: Developing autonomous agents through learning”, Artificial intelligence, 71(2):321-370, 1994; (ii) J. Randlov and P. Alstrom, “Learning to drive a bicycle using reinforcement learning and shaping”, in Proceedings of the 15th International Conference on Machine Learning (ICML'98), pages 463-471, 1998; and (iii) A. Brohan et al, “Rt-1: Robotics transformer for real-world control at scale” ArXiv, abs/2212.06817, 2022.

In discussing reward shaping, M. Dorigo and M. Colombetti. “Robot shaping: Developing autonomous agents through learning”, Artificial intelligence, 71(2):321-370, 1994, states: “[T]here are many different ways in which one may attempt to shape the agent's behavior . . . [S]tart with some intuitive idea of a target behavior in mind. [A]sk [w]hat shaping policy (i.e., strategy in providing reinforcements) can actually steer the agent toward the target behavior. This process is iterative, in that difficulties in finding, say, an appropriate shaping policy may compel [ ] backtrack[ing] and modify[ing] previous design decisions.”

In discussing reward shaping, J. Randlov and P. Alstrom, “Learning to drive a bicycle using reinforcement learning and shaping”, in Proceedings of the 15th International Conference on Machine Learning (ICML'98), pages 463-471, 1998, states: “The idea of shaping . . . is to give the learning agent a series of relatively easy problems building up to the harder problem of ultimate interest[, including] rewarding successive approximations to the desired behavior[.] Shaping can be used to speed up the learning process for a problem or in general to help the reinforcement learning technique scale to large and more complex problems . . . . There are at least three ways to implement shaping in reinforcement learning: By lumping basic actions together as macro-actions, by designing a reinforcement function that rewards the agent for making approximations to the desired behavior, and by structurally developing a multi-level architecture that is trained part by part.”

In discussing learning “robot policies to solve language-conditioned tasks from vision,” A. Brohan et al, “Rt-1: Robotics transformer for real-world control at scale” ArXiv, abs/2212.06817, 2022, states: [C]onsider a sequential decision-making environment. At timestep t=0, the policy π is presented with a language instruction i and an initial image observation x₀. The policy produces an action distribution π(•I i, x₀) from which an action a₀ is sampled and applied to the robot. This process continues, with the policy iteratively producing actions aₜ by sampling from a learned distribution π(•I i, {xⱼ})ⱼ₌₀^{t}) and applying those actions to the robot. The interaction ends when a termination condition is achieved. The full interaction i, {(xⱼ, aⱼ)}ⱼ₌₀^{T} from the starting step t=0 to terminating step T is referred to as an episode. At the end of an episode, the agent will be given a binary reward r∈{0, 1} indicating whether the robot performed the instruction I. The goal is to learn a policy π that maximizes the average reward, in expectation over a distribution of instructions, starting states x₀, and transition dynamics.”

In discussing transformers, A. Brohan et al, “Rt-1: Robotics transformer for real-world control at scale” ArXiv, abs/2212.06817, 2022, states: “[Robotics Transformer 1] uses a Transformer [ ] to parameterize the policy i. Generally speaking, a Transformer is a sequence model mapping an input sequence {ξₕ}ₕ₌₀^{H} to an output sequence {Yₖ}ₖ₌₀^{K} using combinations of self-attention layers and fully-connected neural networks. While Transformers were originally designed for text sequences, where each input ξᵢ and output yₖ represents a text token, they have been extended to images [ ] as well as other modalities [ ] . . . [P]arameterize π by first mapping inputs i, {xⱼ}ⱼ₌₀^{T} to a sequence {ξₕ}ₕ₌₀^{H} and action outputs aₜ to a sequence {yₖ}ₖ₌₀^{K} before using a Transformer to learn the mapping {ξₕ}ₕ₌₀^{H}→{yₖ}ₖ₌₀^{K}.”

In one embodiment, the LLMs are prompted to generate a reward function evaluator function that learns from the behavior of the autonomous machine and the rewards granted by the automated reward function. The reward function evaluator function may track the progress of the reward function towards incentivizing the autonomous machine in reaching a goal. For example, if the reward function leads the autonomous machine away from a goal in consecutive steps, the reward function evaluator may flag the state of the autonomous machine and the reward or lack of reward given that led the autonomous machine to go further from the goal.

Once the reward function evaluator function identifies one or more states and one or more rewards that de-incentivized goal-achieving behavior of the autonomous machine, the reward function evaluator function may prompt one or more LLMs to update the reward function to better incentivize or de-incentivize subsequent behavior after the autonomous machine reaches a certain position that resulted in consecutive steps led away from the goal.

### 4. Automatic Reward Generation

As described in this section, executable source code (which source code may be interpreted directly at runtime or require compilation before runtime) of a reward function is generated using LLMs according to a textual description of a task. In robotic manipulation, common task-independent components address bonuses for lifting objects and penalties for the number of actions to achieve a given purpose. Task-dependent components are driven by the textual task description and align constraints with penalties and guidelines with bonuses. Both components are combined in a global reward function.

In various embodiments, the LLMs may be prompted to provide incremental rewards for incremental progress towards a goal and/or incremental penalties for steps away from the goal, such that smaller rewards are provided for slower, more indirect, or tangential progress towards the goal and larger rewards are provided for faster, more direct, or straightforward progress towards the goal. Similarly, smaller penalties may be provided for slight or indirect steps away from the goal, and larger penalties may be provided for larger steps away from the goal.

For the composition of a global reward function, categories of tasks with their environments are formalized using programing languages, such as YAML or Python, to provide task dependent reward components such as what exists in repositories such as Isaac Gym (i.e., NVIDIA's physics simulation environment for reinforcement learning research). The methods described in this section align the use of a textual task description with a related task category to generate the task-dependent part of the reward function to form the global function.

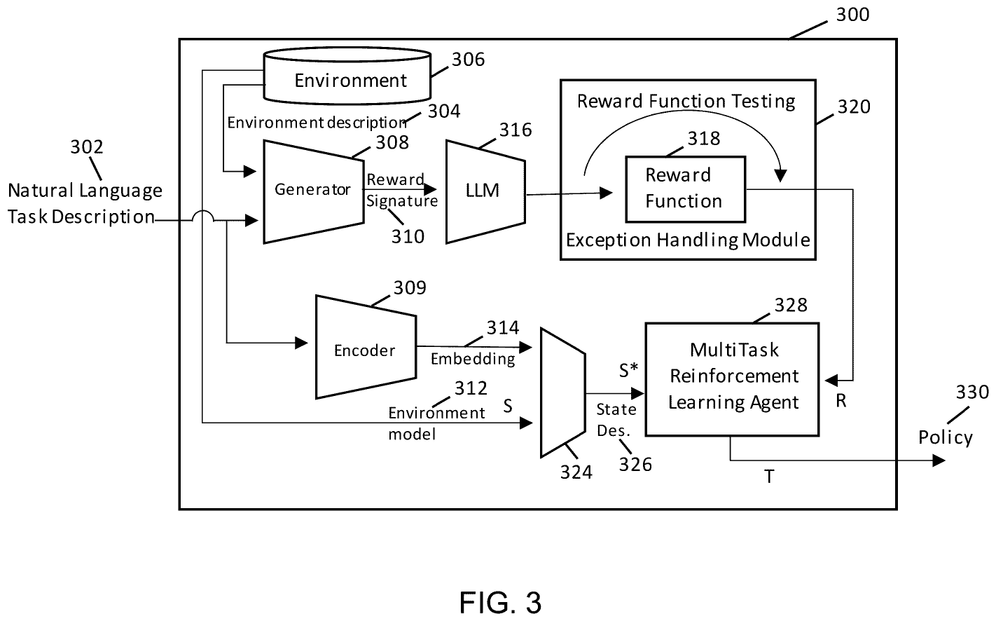

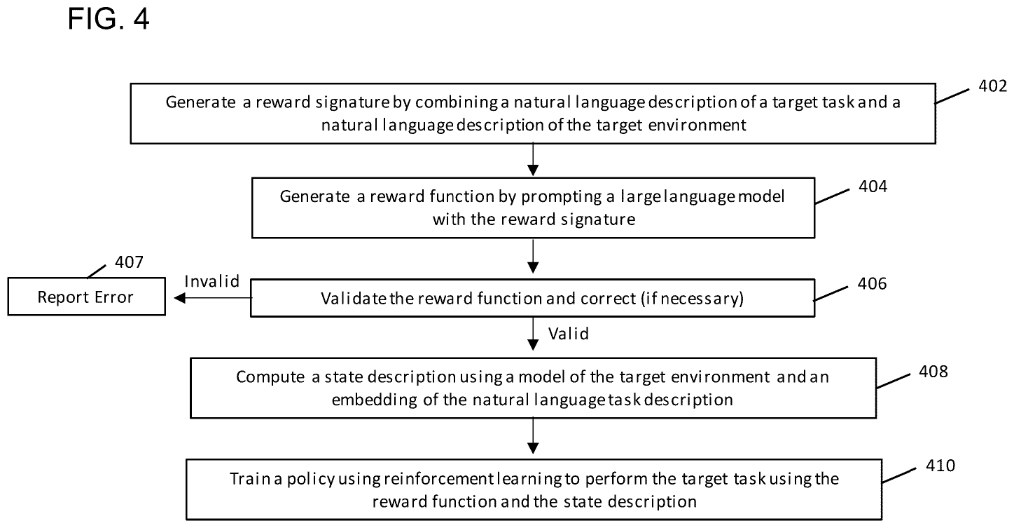

FIG. 3 is a functional block diagram 300 of the training module 118 for training a policy for performing a task of the autonomous machine 106. FIG. 4 is a flow diagram of a method for training a policy for performing a task using the task training module 300. The method uses LLMs to generate a reward function associated with a given textual description of a task, where the trained policy takes as input the textual description of the task.

At 402, a reward signature 310 is generated by generator 308 by combining a natural language description of a target task 302 and a natural language description of the target environment 304 of the autonomous machine 106 (which is a subset of its target environment 306). The target environment 306 describes the state of the autonomous machine (e.g., location and position of joints) and its surroundings (e.g., proximity to a table). In one form the target environment 306 is represented by an environment model 312. In one embodiment, the target environment 306 is predefined in memory 112. In another embodiment, the target environment is generated using camera 210 and sensors 212 of the autonomous machine 106.

In one example, a state may indicate where different portions of the autonomous robot are located relative to the environment, an orientation, direction, speed, velocity, or acceleration, of different portions of the autonomous robot, where different object(s) or portions thereof are located relative to the environment, an orientation, direction, speed, velocity, or acceleration of the different object(s) or portions thereof, such that a reward function can compare this position, orientation, direction, speed, velocity, and/or acceleration information with one or more goal positions, orientations, directions, speeds, velocities, and/or accelerations to determine whether the autonomous machine is making progress towards the goal.

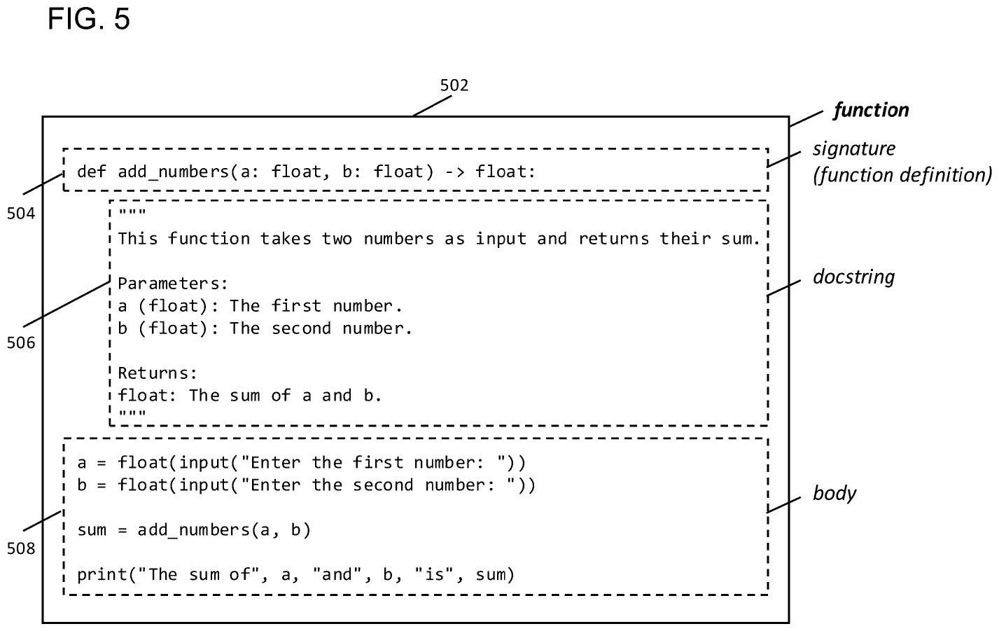

FIG. 5 illustrates elements of an example function 502 in the python language, which includes a signature (or function definition) 504, a docstring 506, and a body 508. The signature 504 defines parameters of the function. The docstring as used herein is a section of a program (e.g., the program 502) that is delimited between a set of quotes (e.g., three quotes or an alternate delimiter) and is ignored when the program is executed or compiled. One typical use of a docstring is to describe the parameters included in the signature of a function and what the function returns. In this example, the parameters of the signature 504 are “a” and “b” and the function 502 returns the sum of “a” and “b” as described in the docstring 504. The body 508 includes computer instructions that are performed when the function 502 is executed (or in an alternate embodiment when the instructions are compiled).

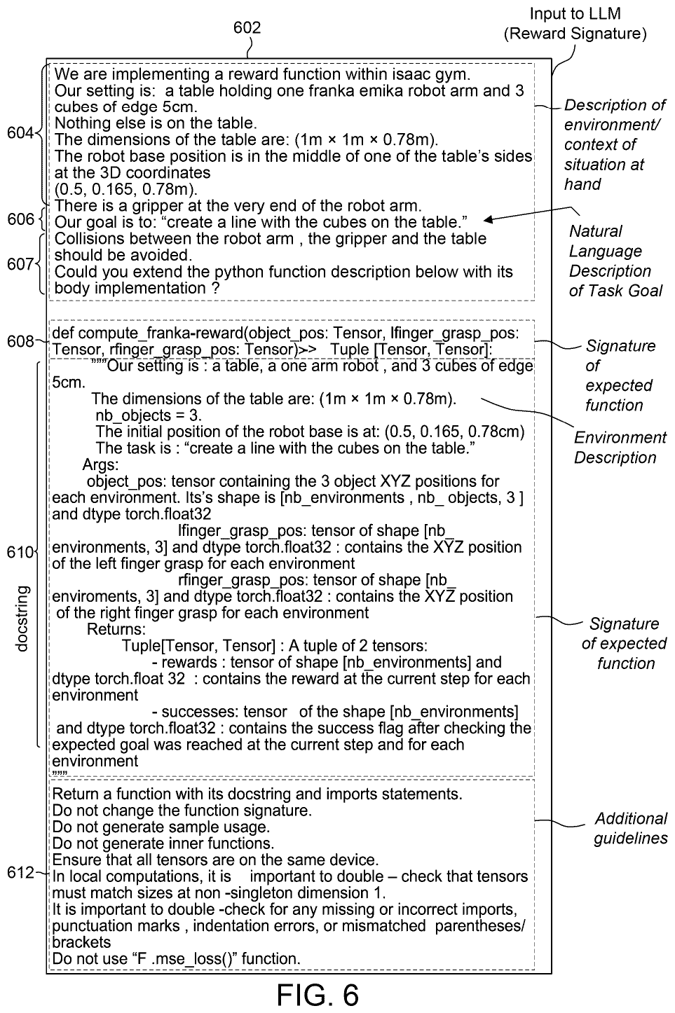

FIG. 6 illustrates an example reward signature 602 generated by generator 308 (shown in FIG. 3), which is defined at 606 by the natural language task description 302 and the remainder of the reward signature 602 by the natural language environment description 304. With reference to the elements of the function illustrated in FIG. 5, the reward signature 602 in FIG. 6 includes a function definition 608 and docstring 610. In the function definition 608, there exists parameters of the reward function that are defined by the environment 306 (e.g., position of an object, position of a left finger grasp, and position of a right finger grasp). In the docstring 610, the environment of the autonomous machine and the parameters of the function definition 608 are described. In addition, the reward signature 602 may also include at 604 a description of the setting of the environment, a request at 607 to generate the body of the function definition, and at 612 guidelines for generating the function definition.

In various embodiments, the description of the setting 604 may include dimensions, positions, movement, behaviors, and/or other characteristics of object(s) in the environment, of the autonomous machine, and/or boundaries and topography of the environment. The request 607 may include added constraints, for example, to avoid common pitfalls, for safety, or to improve the consistency by which the task is completed successfully. The function definition 608 may include structural constraints of the expected function, specifying that the function's processes are to be provided within a given code structure or partial code structure, in a given programming language, using given libraries, with a given sub-structure, with given arguments or inputs, and/or with given returns or outputs.

In one embodiment, additional guidelines 612 may include default guidelines which may be specific to a given LLM and/or category of environments or task types. Additional guidelines 612 may also be learned from errors detected and analyzed during a validation and testing step, as text that has been generated by an LLM with the purpose of fixing errors analyzed by the LLM. The errors may occur in code previously generated by the LLM, and the errors may be detected during production or during tests, such as those generated by the LLM.

The docstring 610 may be manually generated or automatically generated by the system based on the setting 604, the request, 607, the natural language description of the task goal 606, other parts of the reward signature 602, and/or the signature of the expected function 608. The docstring 610 restates these elements of information in an organized manner marked by commenting, to be commented out of code to be generated. The docstring 610 may include standard sections, such as a section about the environment, a section about the arguments of the function to be generated, and a section about the return or output of the function to be generated. Once generated for a given signature of an expected function 608, aspects of the arguments and outputs section may be re-used or modified for inclusion in future docstrings. Similarly, once generated for a given environment, aspects of the environment section may be re-used or modified for inclusion in future docstrings.

More specifically, the prompt structure, as illustrated in FIG. 6 for reward (or goal) generation, includes four parts, organized as follows: (1) the environment description 604, (2) the task (or goal) description 606, (3) the specifications of the expected function 610 and (4) additional guidelines 612. First, the environment description 604 starts with a reference to a specific category of task and then provides additional details to be considered to accomplish the task. It completes the context used by LLM 316 (shown in FIG. 3 and discussed in more detail below) with elements such as the initial environment state, robot specifics, and any other relevant information like a scene description. It also includes technical guidelines such as API or methods to be used. Second, the task description 606 is a text detailing the purpose of the task. It is also used to caption the task in the MTRL approach. Third, to enforce the coherence of the generated output, the signature 608 of the expected function is provided, either for goal or reward generation, listing all parameters along with the expected returned elements. This signature 608 is completed by a docstring 610 detailing the role of each parameter. Finally, additional guidelines 612 are added to drive the code generation. These additional guidelines 612 allow for mitigating frequently observed errors due to limitations in LLM 316. For instance, one constraint is to push data into specific devices (e.g., in the CPU or GPU). Such limitations can be automatically captured by the methods discussed herein that relate to code validation and auto-correction.

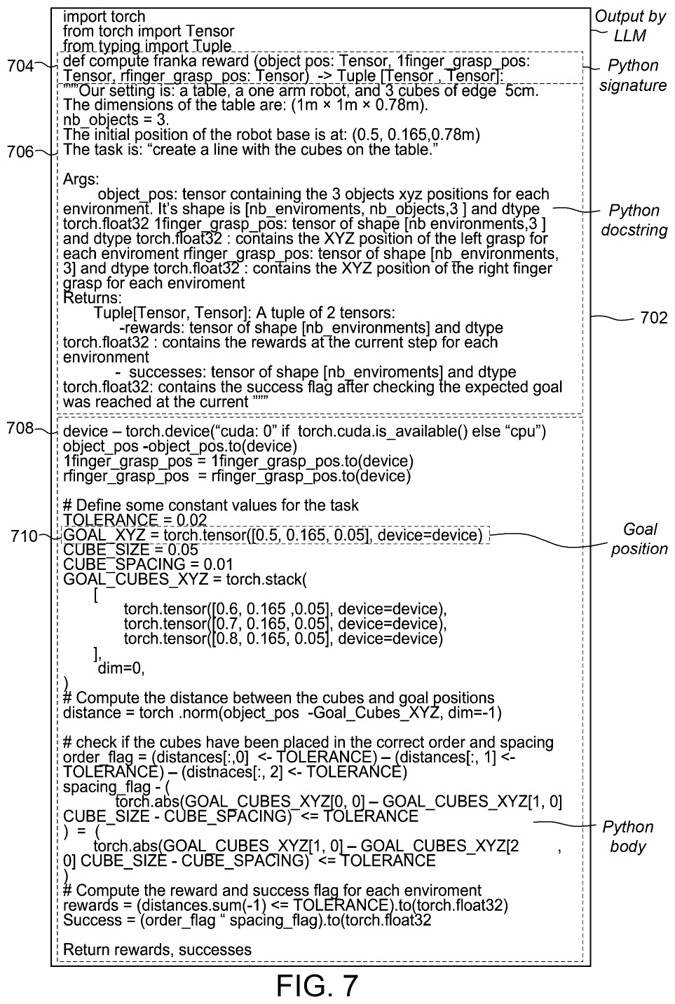

Referring again to FIGS. 3 and 4, a reward function 318 is generated at 404 by prompting large language model (LLM) 316 with the reward signature 310. In effect at 404, the task training module 118 performs automatic reward function generation using LLM 316 to generate reward function 318 associated with the textual description of a task 302 and the environment 304. FIG. 7 illustrates an example 702 of the reward function 318 output by LLM 316 prompted using reward signature 310. With reference to the elements of the function illustrated in FIG. 5, the reward function 702 includes function definition 704, docstring 706 and body 708. The body 708 includes a goal 710 corresponding to the task goal 606 in the reward signature 602.

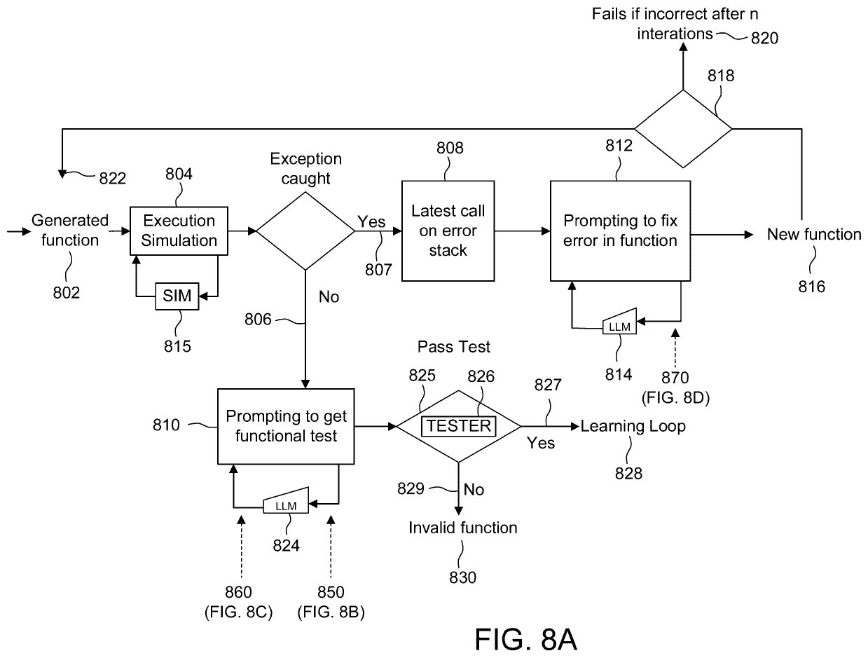

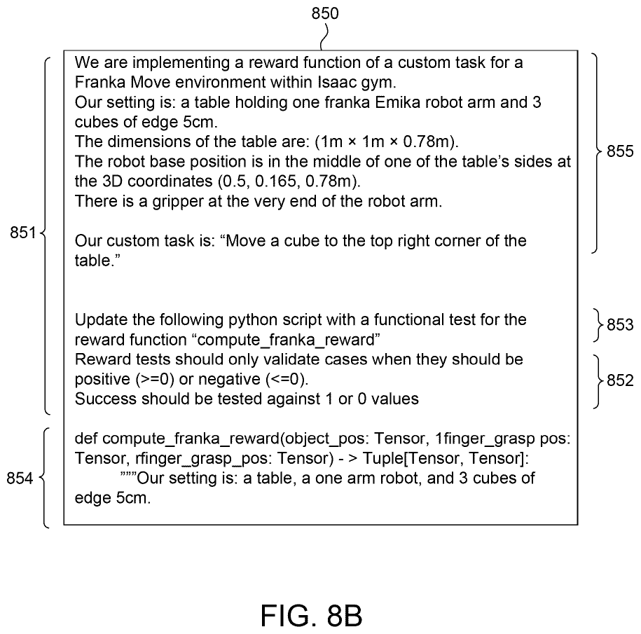

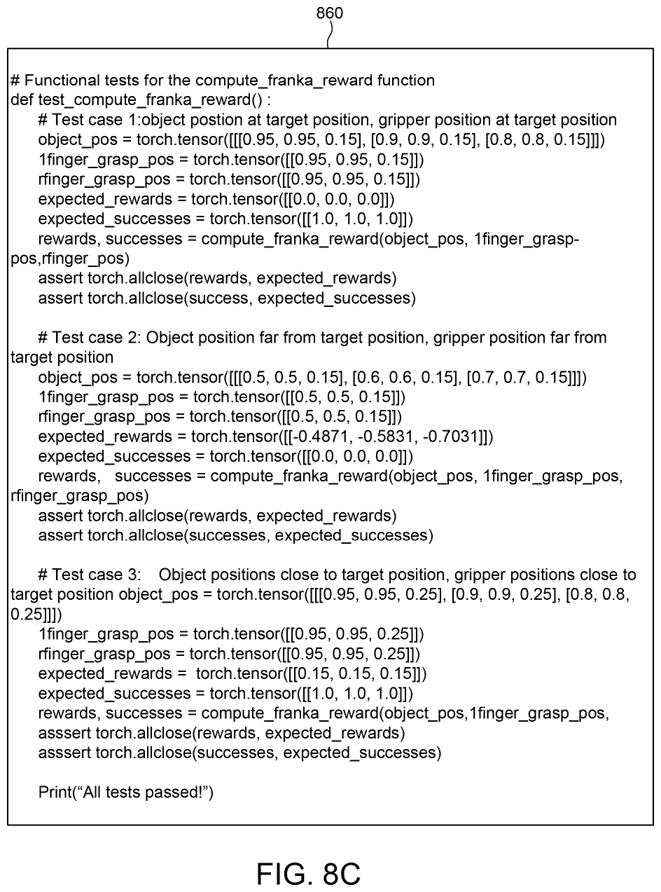

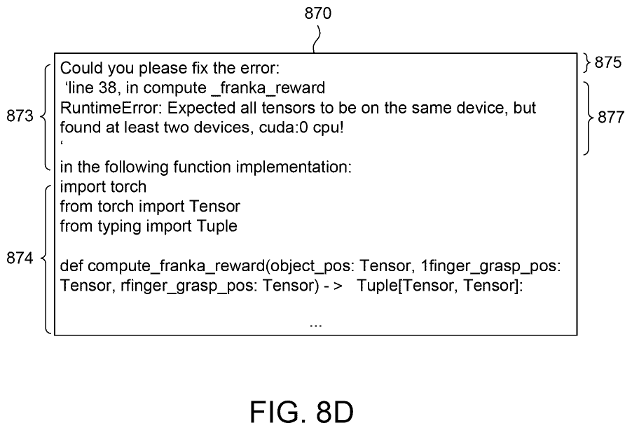

Referring again to FIGS. 3 and 4, the reward function 318 is validated and corrected (if necessary) at 406 by reward function testing and exception handling module 320. FIG. 8A illustrates a flow diagram of a method for carrying out reward function testing and exception handling by module 302 in FIG. 3. At 802, the reward function 318 generated by LLM 316 is executed in simulation at 804 by a simulator 815 adapted to execute the reward function 318 (e.g., function 702 in FIG. 7) generated by the LLM 316. In the event an exception is raised at 807, the simulator 815 catches the exception at 807 and extracts the latest call on the error stack at 808 and prompts, at 812, LLM 814 to generate, at 816, a new function that fixes identified runtime error in the function. For example, simulator 815 may experience error(s) due to invalid data types being used, limits being exceeded, malformed code, infinite loops, memory exceptions, incorrect references, or for any other reason that prevents reward function 318 from properly functioning. Simulator 815 may then prompt, at 812, LLM 814 to generate, at 816, a new function that fixes the corresponding error(s)

An example prompt is shown at 870 in FIG. 8D, with the description of the request to be performed by the LLM 814 that includes at 873 the latest example extracted runtime error 808 of “line 38, in compute_franka_reward RuntimeError: Expected all tensors to be on the same device, but found at least two devices, cuda:0 cpu!,” which is shown at 877, and a request to correct the runtime error 808, “Could you fix the error:” at 875, and a copy the function generated at 802 or 822 at 874. The steps 804, and if necessary 808, are repeated with the new function 816 at 822 in place of the original function.

More generally, the code generated by the LLM (e.g., Python code 702 in FIG. 7) is not guaranteed to meet expectations in terms of code validity or outcomes. As a consequence, further prompt iterations are performed, emphasizing the elements that need to be modified until the result converges (e.g., no exceptions are caught at 807). Errors raised during simulation at 804 generally come from under-specified elements in the original prompt or from LLM limitations such as hallucinations. Therefore, the code generation is finalized with an automatic validation step at 804 in FIG. 8A which exploits the output of simulator 815 (e.g., a Python interpreter).

The code at 802 or 822 generated by the LLMs 316 or 814, respectively, is executed on placeholder input variables and the exceptions raised by simulator 815 are caught when the code fails either to pass the syntax evaluation step or the execution step. The thread of exceptions is filtered to only keep the latest stack and use the error message to fill a prompt requesting code modifications. The prompt to LLM 814 to fix an error in a function (e.g., code at 802 or 822 generated by the LLMs 316 or 814), an example of which is illustrated at 873 in FIG. 8D, contains: (1) a header that requests the LLM to fix the raised exception 875, (2) text of the raised exception 877, and (3) the code of the incorrect function 874. Several iterations of steps 804, 807, 808, and 812 may be required until the code converges toward a version that may execute with no exceptions at 806.

With continued reference to FIG. 8A, in the event exceptions continue to be caught at 807 by the simulator 815 after a predetermined number of iterations n at 818 then the operation fails and an error is reported at 820 (407 in FIG. 4), terminating the operation; otherwise, if no exceptions are caught at 806 by the simulator 815 then the LLM 824 is prompted at 810 to generate functional tests to test the function generated at 802 or 822. An example prompt to LLM 824 is shown at 850 in FIG. 8B, with the description of the request to be performed by the LLM 814 that includes a request for a functional test, at 851, and a copy of the function at 802 or 822 is set out at 854. An example functional test produced by LLM 824 is shown at 860 in FIG. 8C. That is, once code 802 or 822 generated by LLMs 316 or 814, respectively, is executed without an exception being caught at 806, another prompt is used to request the LLM 824 to generate tests to evaluate to the code generated by LLMs 316 or 814.

Functional tests are implemented to test the validity (in terms of functionality) of the reward function which has been simulated in at 804 and determined not to raise an exception at 806. The functional tests themselves may also be tested using processes similar to those shown in FIG. 8A, where the functional test is treated as a generated function that may be simulated to check for errors, such as syntax errors, and where an LLM may be prompted to fix the errors and generate a new functional test.

Referring again to FIG. 8A, at 825, a tester 826 assesses whether the generated function at 802/822 passes the functional test produced by the LLM 824, at 810. If the functional test is passed at 827, the process resumes at 828 policy learning (at 408 in FIG. 4); otherwise, if the functional test fails at 829, the process terminates at 830 with an invalid function error report (at 407 in FIG. 4). This additional validation step at 825 performed by tester 826 is intended to further filter out potentially incorrect code prior to running it in an actual environment (as opposed to a simulated environment). As discussed above, the example prompt 850 illustrated in FIG. 8B, is composed of 1) environment description 855, 2) a header requesting the LLM to generate a functional test 853, 3) a list of guidelines to condition the test 852, and 4) the code of the generated function 854.

Referring again to FIGS. 3 and 4, a state description 326 is computed at 408 by encoder 324 using a model of the target environment 312 and an embedding 314 of the natural language task description 302 (which is produced by encoder 309). In one embodiment, encoder 309 includes a pre-trained text encoder such as Google T5 (Text-To-Text Transfer Transformer) to tokenize and encode the text 302 into embedding vector 314. At 410, a policy 330 is trained using a multitask reinforcement learning agent 328 (e.g., by solving an MDP) to perform the task 302 (T) using the reward function 318 (R) and the state description 326 (S).

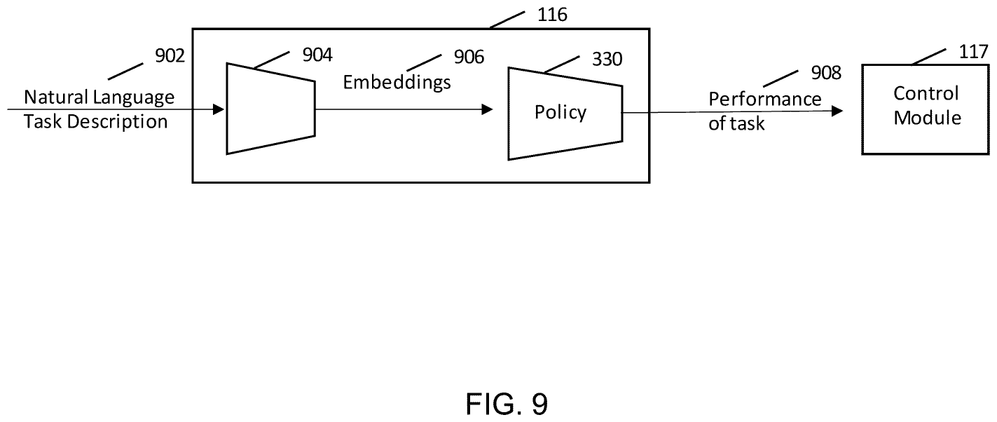

FIG. 9 illustrates a functional block diagram for using the policy 330 trained using the task training module 300 shown in FIG. 3 during inference. During inference as shown in FIG. 9 for the MTRL training loop, embeddings 906 of the natural language (textual) description of a task 902 (which is representative of the natural language task description 302 input to the task training module 300 (as shown in FIG. 3)) are produced by encoder 904 that may form part of solver module 116 of the autonomous machine 106. Subsequently, a performance task 908 is generated when the embeddings 906 are processed by the policy 330 of solver module 116, which may then be used to drive the control module 117 of the autonomous machine 106.

### 5. Automatic Goal Generation

As described in this section, a first objective of automatic goal generation is to translate a textual task description with its constraints and guidelines into a goal. Categories of tasks along with their environment settings and associated reward functions that are parameterized with a goal are assumed to exists for a specific task environment. By way of example, in tabletop robotic manipulation scenarios, a task consists in rearranging a set of objects composing a scene. Further, the goal is assumed to be the set of target poses for all objects. Then, the reward function incorporates environment-dependent reward terms and Euclidian distance between the current pose of the objects and the target pose. Goals generated by the methods set forth hereunder are used in a GCRL learning setting to compute the reward signal at each step. The prompt design p generates a function ƒ returning eligible values for the targeted task such as ƒ→c_{g} where c_{g}=[goal values].

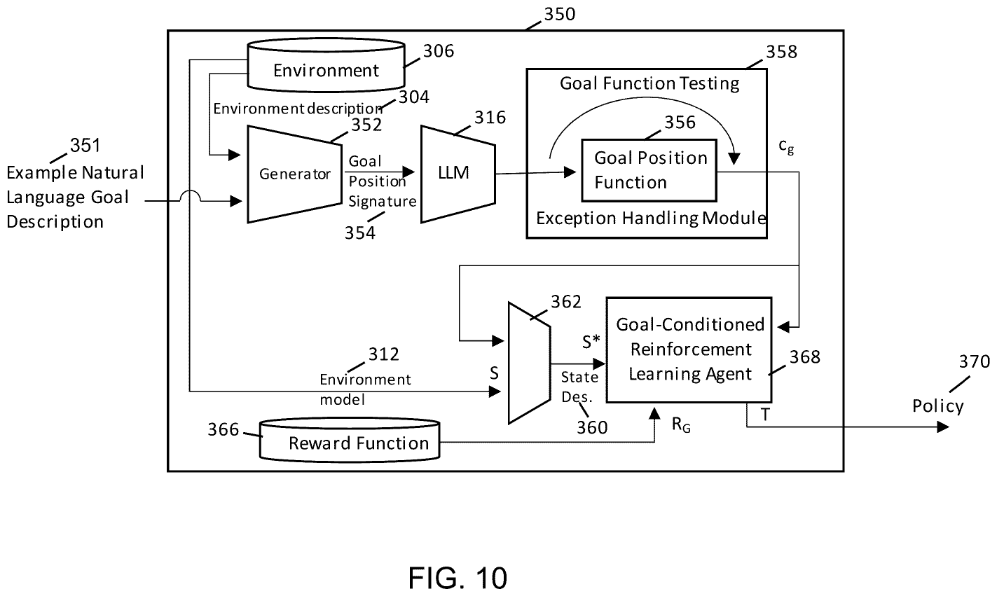

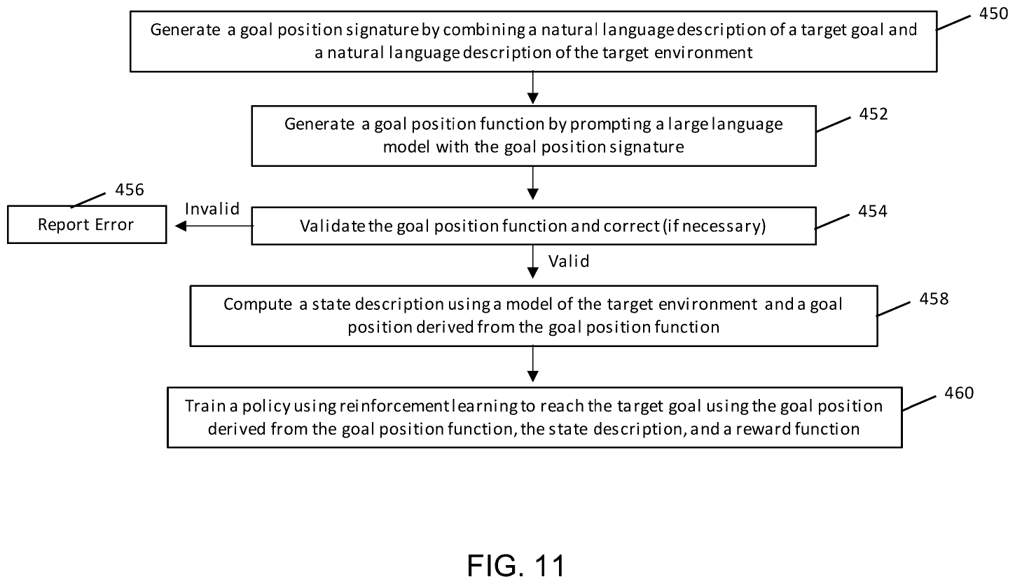

FIG. 10 is a functional block diagram 350 of the training module 118 for training a policy for performing a goal of the autonomous machine 106. FIG. 11 is a flow diagram of a method for training a policy for performing a goal using the goal training module 350. The method uses LLMs to produce executable code that generates goals (c_{g}) to be used as parameters of a predefined goal-conditioned reward function (R_{G}), where the trained policy can take as input a goal generated from such a function. Unlike the embodiment set forth in FIGS. 4 and 5 which trains a policy based on a natural language task description 302, the embodiment set forth in FIGS. 10 and 11 trains a policy based on a natural language goal description 351.

At 450, a goal position signature 354 is generated by generator 352 by combining a natural language description of a target goal 351 and a natural language description of the target environment 304 of the autonomous machine 106 (which is a subset of its target environment 306). Similar to the embodiment set forth in FIGS. 4 and 5, the target environment 306 describes the state of the autonomous machine (e.g., location and position of joints) and its surroundings (e.g., proximity to a table). In one form the target environment 306 is represented by an environment model 312. In one embodiment, the target environment 306 is predefined in memory 112. In another embodiment, the target environment is generated using camera 210 and sensors 212 of the autonomous machine 106.

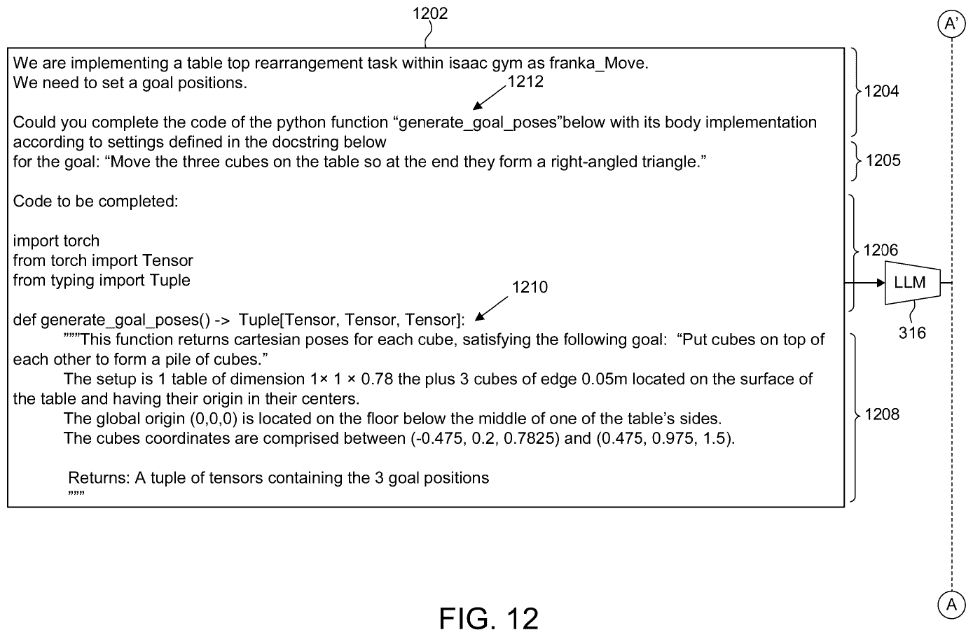

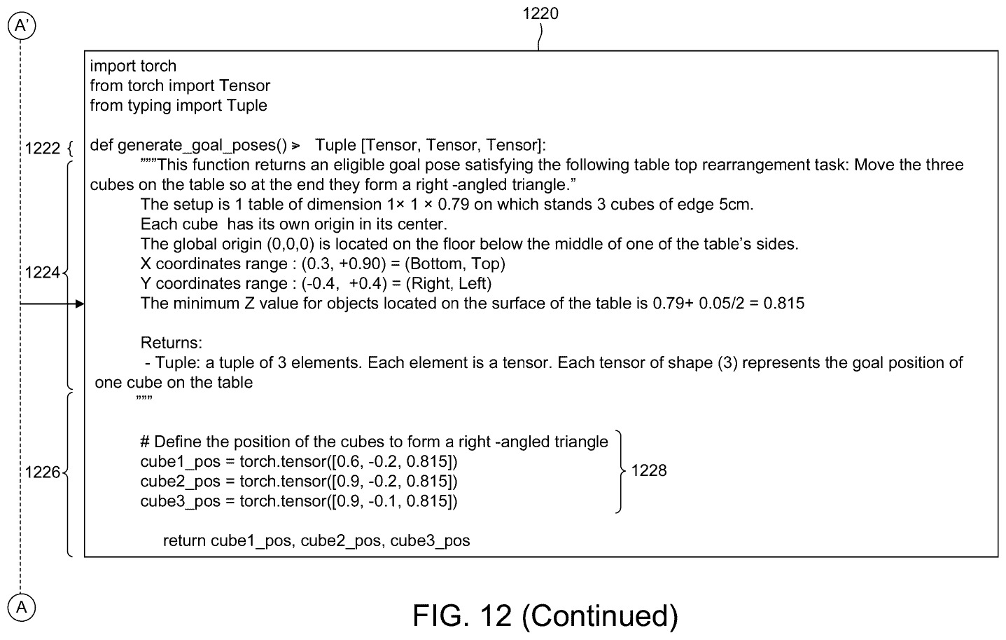

FIG. 12 illustrates an example goal position function 1220 generated by LLM 316 (shown in FIG. 10) from example goal position signature 1202, which is defined at 1205 by the natural language goal description 351 and the remainder of the goal position signature 1202 by the natural language environment description 1204, 1206 and 1208. With reference to the elements of the function illustrated in FIG. 5, the goal position signature 1202 in FIG. 12 includes a function definition 1210 and docstring 1208. In the function definition 1210, there exists parameters of the goal position that are defined by the environment 306 (e.g., position of an object, position of a left finger grasp, and position of a right finger grasp). In the docstring 1208, the environment of the autonomous machine and the parameters of the function definition 1210 are described. In addition, the goal position signature 1202 may also include at 1204 a description of the setting of the environment and a request at 1212 to generate the body of the function definition.

Referring again to FIGS. 10 and 11, a goal position function 356 is generated at 404 by prompting large language model (LLM) 316 with the goal position signature 354. In effect at 452, the goal training module 118 performs automatic goal position function generation using LLM 316 to generate goal position function 356 associated with the textual description of a goal 351 and the environment 304. Referring again to FIG. 12, there is illustrated an example 1220 of the goal position function 356 output by LLM 316 prompted using goal position signature 354. With reference to the elements of the function illustrated in FIG. 5, the goal position function 1220 includes function definition 1222, docstring 1224 and body 1226. The body 1226 includes a goal position 1228 corresponding to the natural language goal description 1205 in the goal position signature 1202.

Referring again to FIGS. 10 and 11, the goal position function 356 is validated and corrected (if necessary) at 454 by goal function testing and exception handling module 358. Referring again to FIG. 8 which illustrates a flow diagram of a method for carrying out reward function testing and exception handling by module 358 in FIG. 10. At 802, the goal position function 356 generated by LLM 316 is executed in simulation at 804 by a simulator 815 adapted to execute the function (e.g., function 1220 in FIG. 12) generated by the LLM 316. In the event of an exception at 807, the simulator 815 catches the exception at 807 and extracts the latest call on the error stack at 808 and prompts, at 812, LLM 814 to generate, at 816, a new function that fixes identified runtime error in the function.

With continued reference to FIG. 8, in the event exceptions continue to be caught at 807 by the simulator 815 after a predetermined number of iterations n at 818 then the operation fails and the error is reported at 820 (at 456 in FIG. 4), terminating the operation; otherwise, if no exceptions are caught at 806 by the simulator 815 then the LLM 824 is prompted at 810 to generate functional tests to test the function generated at 802 or 822. At 825, a tester 826 assesses whether the generated function at 802/822 passes the functional test produced by the LLM 824 at 810. If the functional test is passed at 827, the process of FIG. 11 resumes at 828 policy learning (at 458 in FIG. 11); otherwise, if the functional test fails at 829, the process of FIG. 11 terminates at 830 with an invalid function error report (at 456 in FIG. 11).

Referring again to FIGS. 10 and 11, a state description 360 is computed at 458 by encoder 362 using a model of the target environment 312 and a goal position derived from the goal position function 356. At 460, a policy 370 (T) is trained using a goal-conditioned reinforcement learning agent 368 (e.g., by solving an MDP) to reach the goal 351 using the goal position derived using the goal position function 356 (c_{g}), the state description 360 (S), and reward function 366 (R_{G}) that is fixed for the environment 306.

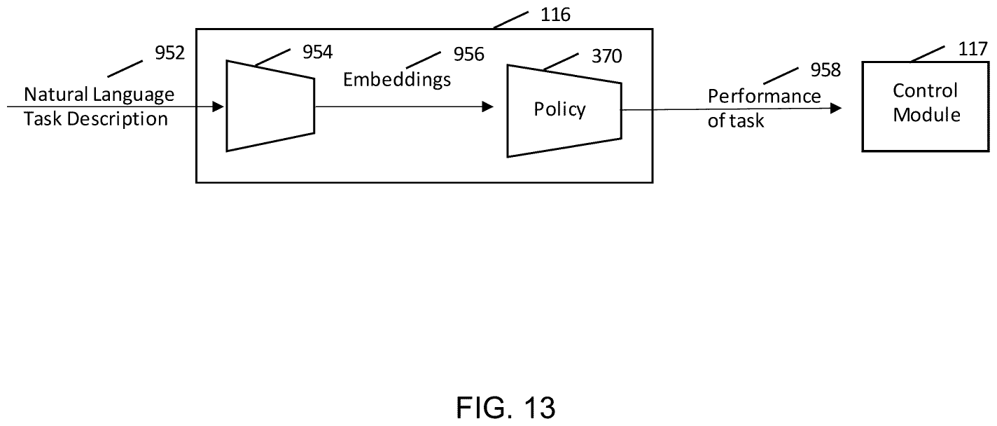

FIG. 13 illustrates a functional block diagram for using the policy 370 trained using the goal training module 350 shown in FIG. 10 during inference. During inference as shown in FIG. 13 for the GCRL training loop, embeddings 956 of the natural language (textual) description of a goal 952 (which is representative of the natural language goal description 352 to the goal training module 350 (as shown in FIG. 10)) are produced by encoder 954 that may form part of solver module 116 of the autonomous machine 106. Subsequently, a performance task 958 is generated when the embeddings 956 are processed by the policy 370 of solver module 116, which may then be used to drive the control module 117 of the autonomous machine 106.

### 7. Metadata for Enriching Automatic Goal and/or Reward Function Generation

In various embodiments and examples, prompts are provided to LLMs to trigger generation of one or more goal position(s), and/or one or more reward function(s) which may be based on one or more goal position(s) determined by the reward function(s) themselves or passed as input into the reward function(s). These prompts may be enriched with various forms of metadata to enrich the automatic goal or reward generation (for example by prompt coordinator 2002 shown in FIG. 20, which receives a natural language request 2004 and gathers information (i.e., metadata) from sources to generate prompt 2016 to LLM 2018).

In one example, the metadata includes various details about the environment, such as:
moveable object position(s) and/or dimension(s) (e.g., blocks or other items that may be grabbed or moved),
immoveable object position(s) and/or dimension(s) (e.g., tables, surfaces, or topographical features),
dimension(s) and/or position(s) of joint(s), profile section(s), or other portions of the autonomous machine, and/or
camera or other sensor position(s) to help the LLM generate a reward function that rewards activity that can be seen or detected by the sensor(s).

The metadata may also include reward function example(s) and/or goal position example(s) for other manually generated or automatically generated (e.g., automatically generated with positive manual feedback) reward function(s) and/or goal position(s) that have been determined to be acceptable for given prompts. One or more examples may be given along with one or more prompts that were provided to produce the one or more examples. These example and prompt pairings help the LLM to understand a context for how an acceptable result may be mapped to a prompt, and the LLM may use the context for determining an acceptable result of a newly provided prompt that has not yet been processed. As the newly provided prompt is different from past prompts of the examples, the LLM may need to adjust the result based on past results, if the prompts are very similar, or generate a new result altogether if the example prompts are very different.

In one embodiment, one or more of the examples include a partial example of a portion of a reward function that is valid for a category of global reward functions. The initial natural language request may be mapped to a particular category of global reward functions based on the content, geometry, environment, code language, or other characteristics associated with the request, and the particular category may include one or more partial reward functions that are specific to those characteristics. Upon retrieving the partial example, a searching tool may include the partial example in a prompt to the LLM with the instructions to include the partial example as part of the result to the initial natural language request for a global reward function. This partial example may be referred to as the task-independent portion of the global reward function that is requested to be generated.

In the same or another embodiment, one or more of the examples include a full or partial example of a reward function that is not valid or not known to be valid for the category of global reward functions covered by the initial natural language request. The initial natural language request may or may not be mapped to a particular category of global reward functions, and, even in the case of a mapping, there might not be any known reward function parts or components that are known to be relevant to a task-independent part and/or a task-dependent part of a reward function requested by the initial natural language request. In this scenario, a search tool may locate a most likely relevant task-independent part, a most likely relevant task-dependent part, and/or a most likely relevant global reward function as code examples for inclusion in the prompt to the LLM. Rather than instructing the LLM to use these code examples as-is in combination with other generated code, the prompt instructs the LLM to use the examples as examples of other task-independent parts, task-dependent parts, and/or global reward functions that addressed other requests for other tasks. The LLM may look at the structure common to the examples and use some context in constructing the result without copying the examples which do not address the natural language request at hand.

Whether the examples are useable in the result or provide helpful context to produce the result, the search tool may look for examples to include in a prompt, improving the guidance to the LLM and refining the results produced by the LLM to be more consistent with results of the past that have been marked with positive feedback.

In one embodiment, in order to provide examples that are closest to a given natural language request, a searching tool receives the given natural language request, optionally determines whether the natural language request is for a goal position or a reward function, and searches a repository of prior examples including, for example, goal positions associated with example natural language requests (such as those successfully handled in the past) and/or reward functions associated with example natural language requests (such as those successfully handled in the past). The example natural language requests in the repository may be compared to the given natural language request based on an overall distance between the text, based on how many infrequently occurring words are shared between the given natural language request and the example natural language request, and/or based on an order or position of the words in the given natural language request, to find one or more examples most closely matching to the given natural language request. The closest example(s) may be included in a prompt to the LLM to provide additional context for producing a resulting goal position and/or reward function.

In one embodiment, the example past results are paired with example past natural language requests. Variations may be generated for the example natural language requests by prompting an LLM to produce variations that mean the same thing but use different language. For example, a prompt may be used such as “Generate n paraphrases for the task below: [natural language request].” These variations may be stored in association with the example natural language requests and their natural language results to promote a more effective search for relevant results.

In the same or a different embodiment, variations of a given natural language request, yet to be processed, may be generated with an LLM to promote searching for examples similar to the given natural language request. Each of the variations of the given natural language request may be matched to closest prior examples, and the closest prior examples may be merged to produce a resulting set of closest prior examples.

In one embodiment, if a variation of the given natural language request matches a variation of an example past natural language request with an example result that received positive feedback, the example result may be used as a response to the given natural language request without attempting to regenerate a response by the LLM. In this approach, the past result is cached, located, and re-used for another request, even if the language of the requests amount to variations of each other and are not the same word-for-word.

In one embodiment, the repository of examples may include examples that are not paired with prior natural language requests. For example, the example may have been manually generated, or the prior natural language request may not have been saved in association with the example. Whether or not an example natural language request is available, the searching tool may perform a search by matching the given natural language request with the content of a prior example to give priority to examples in the same environment, with similar geometrical terms, or with similar functions as those requested by the given natural language request.

In one embodiment, examples may be pulled from repositories that are part of a dataset used to train an LLM, in which case the information is embedded within an accessible from the model's parametric memory. In the same or another embodiment, examples may also be pulled from sources that are independently indexed for matching against future requests. The independently indexed sources may be public or private, including examples that can extend the LLM's background knowledge with external information that may be more relevant to a specific application.

In one embodiment, code examples may be retrieved from a public code repository such as Github or Bitbucket. Code examples from public repositories that have survived community review may serve as good examples even without separate manual review beyond the community at large. If a similar example exists with a community of users, downloaders, implementers, or contributors, for example, the similar example may be included in the LLM prompt. Larger communities and more public engagement may lead to a higher likelihood of inclusion of similar examples from public repositories.

Whether code examples are indexed from a public or private source, examples may be indexed using example code packages as a whole or function by function for a set of functions contained within the example code packages. In one embodiment, each code file in a repository may be segmented into a set of functions, and each function may be indexed individually. In a particular embodiment, the indexing process (I) may combine information from multiple sources, including, for example, the readme.md file (R), the function's signature (S), its docstring (D), and its code (C) (i.e., body). This aggregation can be represented as R, S, D, C→F, where F represents the indexed function. The result is encoded into a collection of embeddings and stored within a vector database for semantic retrieval.

In one embodiment, a preliminary result of a given natural language request is obtained by prompting the LLM without including one or more prior example results in the given prompt. The search tool may use the preliminary result to search for one or more examples, by matching output text of the preliminary result to output text of the past examples, optionally in addition to matching aspects of the natural language request and/or environment. The one or more examples may be included in a second prompt to the LLM that includes the additional metadata to produce a more refined and reliable result from the LLM.

In one embodiment, a user interface is provided for marking examples of reward functions and/or goal positions with positive feedback for inclusion in future prompts. Additional search tags or example context may be included in the feedback to associate the example with prompts relating to certain keywords, topics, environments, or robots. When finding an example for a given request, the search tool may search the example and the search tags or example context to match the example with the given request.

In one embodiment, the user interface also allows the examples to be marked with negative feedback for inclusion in future prompts as steps to avoid. The negative feedback may be similarly tagged and may include additional information about what makes the example a bad example. The additional information, along with the bad example, may be included in future prompts that match closest to the bad example, to encourage the LLM to avoid similar problems going forward.

In one embodiment, a decision on whether or not to provide additional examples of code to the LLM may be determined based on the LLM being used. For example, GPT4 generally performs well when given examples, but StarCoder and HCX did not perform as well using examples. In this scenario, if GPT4 is being used, examples may be appended to improve performance.

In a particular example, a dedicated code database is generated and maintained to support search and retrieval for supplemental examples using a code example repository called The Stack, which is a database that contains 6 TB of source code files covering 358 programming languages as part of the BigCode project. For the sake of performance to help in generating Python code for an autonomous machine, the code example repository is filtered for Python files from sub-repositories related to, for example, robot learning for manipulation tasks. The text-based information found in markdown files associated with each repository may be used to filter down the code examples. Once filtered, the remaining code examples may be indexed and stored in a vector database, such as ChromaDB. The index may include encompassing code, comments, associated natural language prompts or descriptions of what the code does, documentation extracted from code repositories, categorization of the code or functionality, and other information about the code examples. Repository descriptions, comments, and function names are encoded using, for example, SentenceTransformer.

A determination may be made on how many examples to include for a given problem space based at least in part on performance differences observed when different numbers of examples are provided. The alignment, or lack thereof, between the names of the example functions and the name of the targeted one as defined in the signature (S) part of the prompt may also determine how many and whether to include examples. Alignment may also be determined from variations in the names or signatures, or variations in the natural language description of what the functions do, which may also be stored in association with the code examples in the code repository. Based on these factors, any number of examples may be provided. In many embodiments, 1-3 examples are provided to retain the focus on the task at hand while still providing useful context to the LLM. Example approaches to selecting examples include:
using the 2 top-ranked example functions, with or without modifying function names,
using the 3 top-ranked example functions, with or without modifying function names,
using the top-ranked example function, with or without modifying the function name,
using a random example function among the top 4 without considering the best one and with or without modifying the function name, and generating the LLM prompt without an example function.

Different approaches may be used for different scenarios, with different environments, different autonomous machines, different objects, and different tasks.

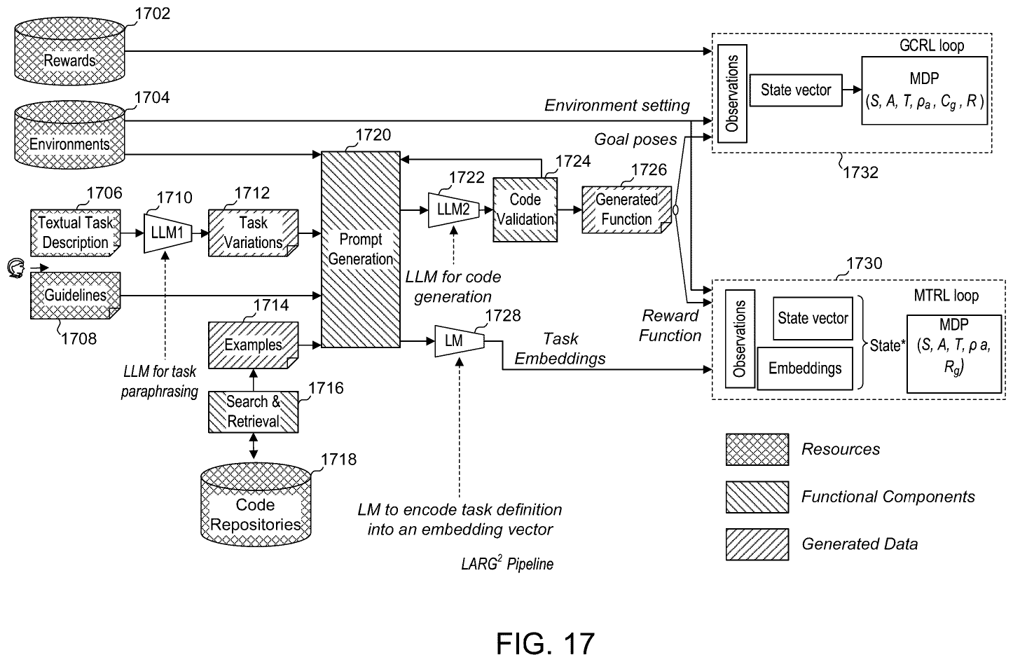

FIG. 17 shows an example system for transforming a textual task description into either 1) a goal to be used as input of a given reward function for GCRL, or 2) a reward function for MTRL. A pre-trained and instructed LLM may be used with dedicated prompts for the generation procedures.

For Goal Conditioned Reinforcement Learning (GCRL), the goal poses and/or goal function generating goal poses may be appended to the state description given as input to the policy in GCRL loop 1732. As shown, the goal poses and/or goal function may result from prompt generation 1720 for input to LLM2 1722. Prompt generation 1720 may receive as input task variations 1712, environment description 1704, guidelines 1708, and/or examples 1714. Task variations 1712 may be provided manually or may be generated by LLM1 1710 using textual task description 1706. Examples 1714 may be provided manually or may be generated using search and retrieval 1716 from code repositories 1718. Prompt generation 1720 sends one or more prompts to LLM2 1722 for generating goal poses and/or a goal function for generating goal poses. Code validation 1724 may validate the goal poses and/or goal function and, if invalid, return to prompt generation 1720 to generate valid goal poses and/or a valid goal function. The code validation loop checks that the generated functions can be properly executed within the GCRL framework. If valid, the goal poses and/or goal function may result in a generated function 1726, which is input into GCRL loop 1732 as valid goal poses and/or a valid goal function to train an autonomous machine using a Markov Decision Process (MDP) based also on information about environments 1704 and rewards 1702.

For Multi-Task Reinforcement Learning (MTRL), the reward function may be appended to the state description given as input to the policy in MTRL loop 1730. As shown, the reward function may result from prompt generation 1720 for input to LLM2 1722. Prompt generation 1720 may receive as input task variations 1712, environment description 1704, guidelines 1708, and/or examples 1714. Task variations 1712 may be provided manually or may be generated by LLM1 1710 using textual task description 1706. Examples 1714 may be provided manually or may be generated using search and retrieval 1716 from code repositories 1718. The examples may include supplemental code examples that are known to be valid for other tasks. Prompt generation 1720 sends one or more prompts to LLM2 1722 for generating a reward function. Code validation 1724 may validate the reward function and, if invalid, return to prompt generation 1720 to generate a valid reward function. The code validation loop checks that the generated functions can be properly executed within the MTRL framework. If valid, the reward function may result in a generated function 1726, which is input into MTRL loop 1730 as a valid reward function to train an autonomous machine using a Markov Decision Process (MDP) based also on information about environments 1704.

In one embodiment, the MTRL loop 1730 receives task embeddings from a language model (LM) 1728, which encodes the task definition into an embedding vector. LM 1728 may encode the text-based task description using a pre-trained language model to complement the state vector. LM 1728 may be prompted using prompt generation 1720, which may receive as input task variations 1712, guidelines 1708, and examples 1714. Task variations 1712 may be provided manually or may be generated by LLM1 1710 using textual task description 1706. Examples 1714 may be provided manually or may be generated using search and retrieval 1716 from code repositories 1718. Prompt generation 1720 sends one or more prompts to LM 1728 for generating the task embeddings. The task embeddings may be provided to MTRL 1730 to train an autonomous machine using a Markov Decision Process (MDP) based also on information about environments 1704 and a generated reward function 1726.

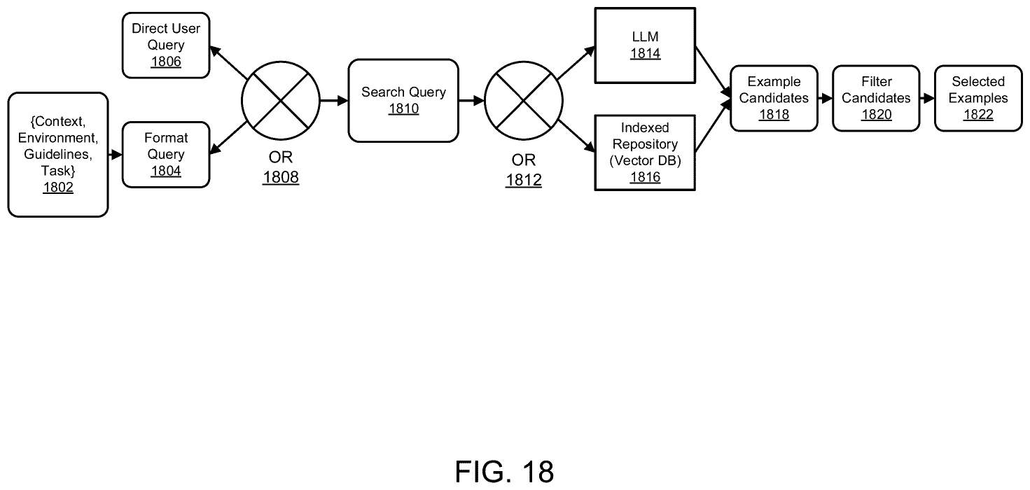

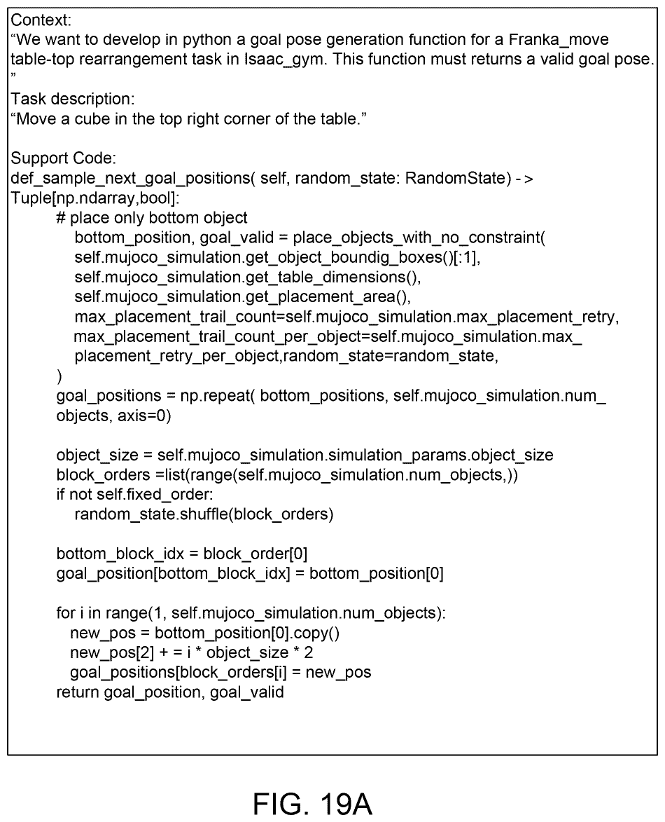

FIG. 18 shows an example search and retrieval pipeline for gathering code examples (e.g., such as examples 1714 shown in FIG. 17). As shown in FIG. 18, search query 1810 may be formulated manually based on a direct user query 1806 or, as determined in block 1808, automatically based on context, environment, guidelines, and task description 1806 to format a query 1804. Search query 1810 is then used to query either the parametric memory of an LLM 1814 or, as determined in block 1812, a code database or other indexed repository 1816 to retrieve function examples. Search query 1810 results in example candidates 1818, which may be filtered in block 1820 to produce selected examples 1822. The selected function examples 1822 may serve as additional context, enriching a dedicated prompt used to convert textual task descriptions into goal poses or reward functions.

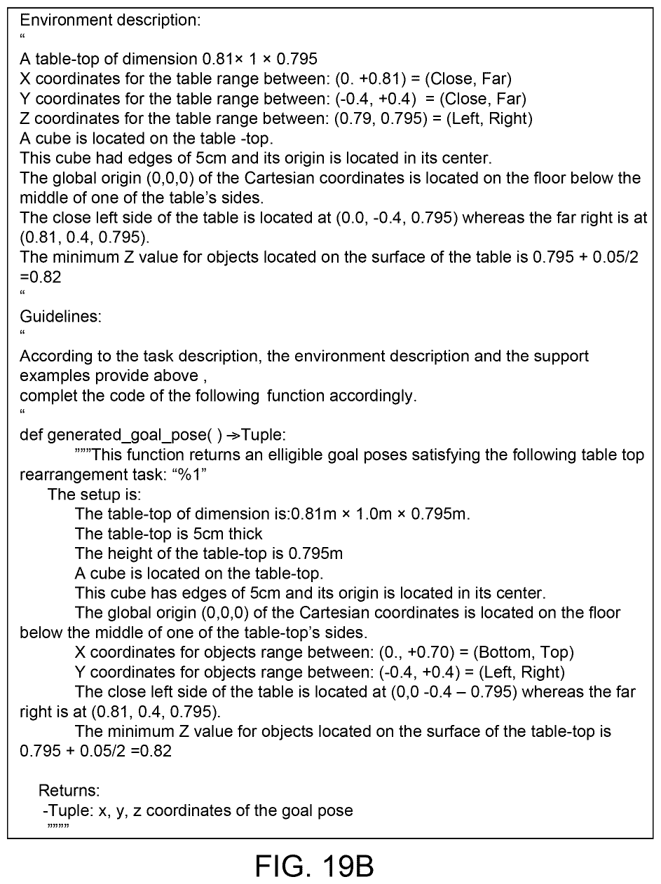

The example system shown in FIG. 17 may use a dedicated prompt with ad-hoc parameters to query LLM 1722 for generating either goal or reward functions. FIGS. 19A-B show an example prompt including example code to provide the LLM with additional context in generating a result. In the example of FIGS. 19A-B, the prompt may be composed of {T, G, C, E, and X} where T task description and C context may be provided by the user, or through paraphrasing, E environment description from a provided dataset that may be referenced or selected in or before the natural language request or used as a default, G guidelines provided by the system, optionally specific to the LLM, to promote a focused result, and optionally X examples either from the parametric memory of an LLM or from queries to an ad-hoc code database.

As shown in FIG. 19A, C is the context or high level description of the objective, such as “We aim to develop a Python function for generating goals for a Franka-Move tabletop rearrangement task within IsaacGym”. T is the task description, and, continuing to FIG. 19B, E is the environmental description that provides information defining the action space. E may include details such as dimensions and locations of objects involved. In FIG. 19A, X is an optional list of code examples (i.e., “Support Code”) to guide intermediate reasoning steps of the LLM. In FIG. 19B, guidelines, G, reflect a summary of instructions which may reference preceding sections and tie them together with the overall request. G may also consolidate the list of elements or constraints that must be taken into account when generating the code. For Chain of Thought (CoT) approach, the purpose is to provide the reasoning schema to be used when generating a more relevant function. In FIG. 19B, S is the signature of the function that needs to be completed (i.e., “def generated_goal_pose( )-Tuple”), followed by a docstring. The specification of these inputs to the LLM provides context so the generating functions may align better with the natural language request's requirements, enabling the resulting function to be executed seamlessly within a larger GCRL or MTRL framework. FIG. 18 illustrates a search and retrieval process for supplemental examples (X).

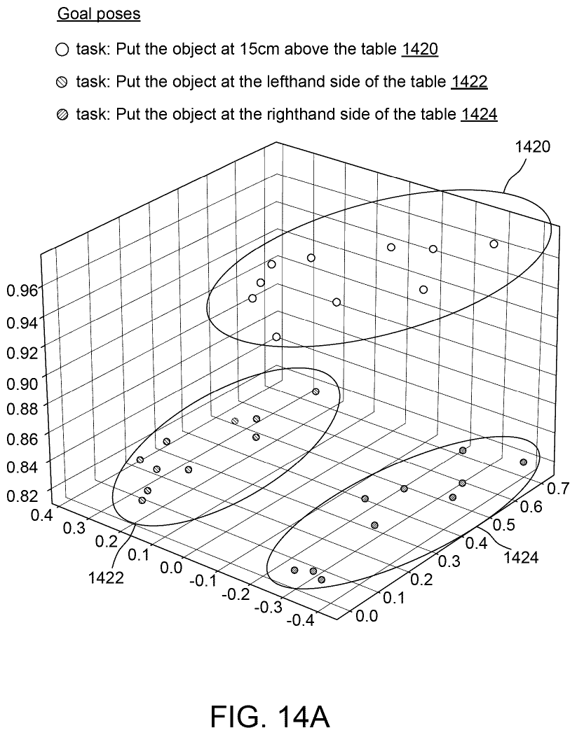

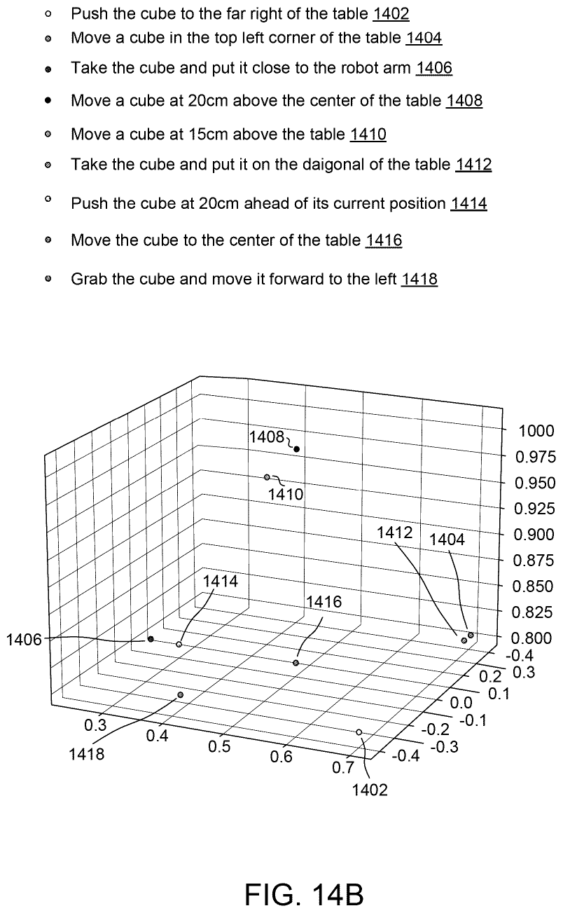

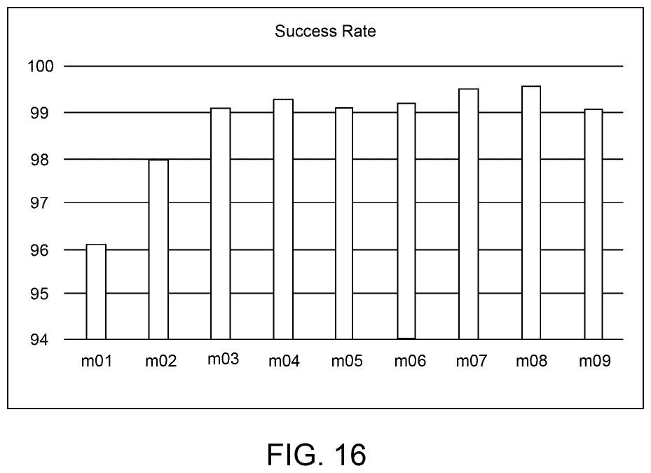

FIG. 14B shows example generated goal positions for nine manipulations tasks, as detailed in the section entitled “Example Language-Based Automatic Reward and/or Goal Generation.” The nine manipulation tasks shown include: (1402) Push the cube to the far right of the table, (1404) Move a cube in the top left corner of the table 1404, (1406) Take the cube and put it close to the robot arm, (1408) Move a cube at 20 cm above the center of the table, (1410) Move a cube at 15 cm above the table, (1412) Take the cube and put it on the diagonal of the table 1408, (1414) Push the cube at 20 cm ahead of its current position, (1416) Move the cube to the center of the table, and (1418) Grab the cube and move it forward to the left. These example goal positions were generated by including example code in the prompt to the LLM. FIG. 16 shows example success rates of MTRL (with example tasks m01, m02, m03, m04, m05, m06, m07, m08, and m09 from Table 3 in the following section) for automatically generating a valid reward function. Based on the success achieved and illustrated, the techniques described herein demonstrate capability of producing valid reward functions to successfully train and execute MTRL policies from textual task descriptions.

### 8. Example Language-Based Automatic Reward and/or Goal Generation

Provided herein are additional details about language-based automatic reward and goal generation (LARG²), as well as experiments performed to evaluate performance for goal-conditioned reinforcement learning (GCRL) and multi-task reinforcement learning (MTRL).

LARG² provides a scalable method to align language-based description of tasks with goal and reward functions to address GCRL and/or MTRL. In one embodiment, LARG² uses code generation capabilities offered by large language models (LLMs). These LLMs capture prior background knowledge and common sense. In terms of coding capabilities, they leverage existing code available in repositories like GitHub. A fully capable LLM could generate proper code from pure textual descriptions. However, experimentation demonstrates that existing LLMs still benefit from additional guidelines provided as context. Such guidelines relate to scene understanding and function signature. One source of information for guidelines is environment descriptions in code repositories. Additionally, scene understanding can be provided by exteroception components that translate images into object captions and geometric coordinates. In a first example, such additional information was gathered from a portfolio of categories of manipulation tasks defined in repositories like Isaac Gym from NVIDIA Omniverse on GitHub with descriptions of environments formalized using languages like YAML or Python. Such environments also provide signatures of expected functions commented with a formalism like Docstring.

In the example, LARG² aligns a text based task description with the appropriate category of tasks and leverages environment descriptions to build an ad-hoc prompt to be used with LLMs. Therefore, code generated by LARG² can be seamlessly integrated into repositories to execute the desired settings.

Textual descriptions of tasks allow to overload generic definitions of tasks available in code repositories. Scalability can therefore be achieved thanks to paraphrasing. Indeed, LLMs can generate task definition variants on a basis of textual seeds to produce large training datasets.

A first example application of LARG² generates goals to be used as parameters of a predefined goal-conditioned reward function.

As an example, in tabletop robotic manipulation scenarios, a pick and place task consists in rearranging a set of objects composing a scene. In such a case, the goal is the set of target poses for all objects, and the reward function basically computes the Euclidian distance between a current object pose and the target pose. LARG² generates functions producing a set of eligible goal positions from textual task descriptions.

In the example, the prompt design used to generate the goal function is composed of the following elements: 1) the environment description, 2) the task description, 3) the specifications of the expected function and 4) optional guidelines.

Example 1 Prompt below shows an example prompt design, and Example 1 of Generated Code below shows example generated code. Example 1 Prompt shows a prompt requesting the generation of the goal function using GCRL. The function signature appears on the lines starting with “import torch” to the end of the example. The text-based goal description appears on two lines, starting with “for the goal:” and ending with “triangle.”

### Example 1 Prompt

We are implementing a table top rearrangement task within isaac gym such as Franka_Move.
We need to set goal positions.
Could you complete the code of the python function “generate_goal_poses” below with its body implementation according to settings defined in the docstring below
for the goal: “Move the three cubes on the table so at the end they form a right-angled triangle.”
Code to be completed:

```
import torch
from torch import Tensor
from typing import Tuple
def generate_goal_poses( ) −> Tuple[Tensor, Tensor, Tensor]:
  ″″″This function returns an eligible goal pose satisfying the following table top
rearrangement task: Move the three cubes on the table so at the end they form a right-
angled triangle.”
  The setup is 1 table of dimension 1 x 1 x 0.79 on which stands 3 cubes of edge
5cm.
  Each cube has its own origin in its center.
  The global origin (0,0,0) is located on the floor below the middle of one of the
table's sides.
  X coordinates range: (0.3, +0.90) = (Bottom, Top)
  Y coordinates range: (−0.4, +0.4) = (Right, Left)
  The minimum z value for objects located on the surface of the table is 0.79 +
0.05/2 = 0.815
  Returns:
  - Tuple: a tuple of 3 elements. Each element is a tensor. Each tensor of shape
(3) represents the goal position of one cube on the table
  ”””
```

Example 1 of Generated Code below shows generated code using GCRL for the goal pose function.

### Example 1 of Generated Code

```
import torch
from torch import Tensor
from typing import Tuple
def generate_goal_poses( ) −> Tuple[Tensor, Tensor, Tensor]:
    ″″″This function returns an eligible goal pose satisfying the following table top
rearrangement task: Move the three cubes on the table so at the end they form a right-
angled triangle.”
    The setup is 1 table of dimension 1 x 1 x 0.79 on which stands 3 cubes of edge
5cm.
    Each cube has its own origin in its center.
    The global origin (0,0,0) is located on the floor below the middle of one of the
table's sides.
    X coordinates range: (0.3, +0.90) = (Bottom, Top)
    Y coordinates range: (−0.4, +0.4) = (Right, Left)
    The minimum z value for objects located on the surface of the table is 0.79 +
0.05/2 = 0.815
    Returns:
    - Tuple: a tuple of 3 elements. Each element is a tensor. Each tensor of shape
  (3) represents the goal position of one cube on the table
    ”””
    # Define the position of the cubes to form a right-angled triangle
    cube1_pos = torch.tensor([0.6, −0.2, 0.815])
    cube2_pos = torch.tensor([0.9, −0.2, 0.815])
    cube3_pos = torch.tensor([0.9, 0.1, 0.815])
    return cube1_pos, cube2_pos, cube3_pos
```

A second example application of LARG² generates the executable source code of a reward function according to a task description.

In one example, for MTRL the policy takes as input the textual description of the task in addition to the state. In such a case, goals are removed from the environment. However this information may be used by the reward function to compute a gain. Therefore, this information is also generated by LARG² according to the provided task description.

For the reward function itself, in one embodiment, the process involves separating components which are task independent from those which are task dependent. In robotic manipulation, task agnostic components address bonuses for lifting the objects or penalties for the number of actions to reach the goal. Due to known limitations in current LLM, in one embodiment, LARG² is focused on generating the part of the reward that depends on the specific guidelines and constraints defined in textual definitions.

The prompt structure used for generating the reward function may be similar to the one used for goal generation. In one embodiment, the prompt structure may be composed of 1) the environment description, 2) the task description, 3) the specifications of the expected function and 4) optional guidelines. However, in this case the function specification may contain the signature of the expected reward function.

The following Example 2 of Generated Code, Example 3 of Generated Code, Example 2 Prompt, and Example 4 of Generated Code show prompts and results obtained when requesting the generation of ad-hoc code for manipulating one cube to bring the cube closer to the robotic arm. Example 2 of Generated Code details the global reward function that combines both elements from the task independent, which is shown in Example 3 of Generated Code, and task dependent part. In this case, LARG² focuses on generating the dependent part using a prompt illustrated by Example 2 Prompt to produce the code shown in Example 4 of Generated Code.

Generation of the reward function (R) may be simplified by identifying the different parts of the function, some being task-independent (I) and others closely related to the task definition (D) so that R is a composition of both parts, R=I+D. In robotic manipulation, common task-independent components address bonuses for lifting the objects or penalties for the number of actions to achieve a given purpose. Once generated for a first task, a reward function part, such as a class, method, or block of code, addressing the task-independent components may be provided to the LLM for other tasks, and the LLM may focus on generation of the reward function for the task-dependent components of the other tasks. Task-dependent components, which are driven by the textual task description, align constraints with penalties (N) and guidelines with bonuses (B). Both components are combined in a global reward function.

To compose this global reward function, tasks may be categorized and associated with their environments, requested languages such as YAML or Python, and other characteristics. The independent reward function components may be used for specific categories, specific environments, specific languages, and/or specific to other characteristics. For example, an independent reward function component may be available in a repository like Isaac_Gym. The search and retrieval step may collect reward components as examples to support full reward generation.

In one embodiment, task-independent components that are found may be prompted to be referenced or called by the code generated by the LLM, without being separately included in the code generated by the LLM. For example, a class or method name and code of a task-independent component may be provided, and a generated task-dependent component may explicitly reference the task-independent component using the class or method name in the generated code, optionally passing parameters into the class or method name by the generated reward function. In this example, the prompt to the LLM may provide the task-independent code as well as an example for how to call the task-independent code.

For the task dependent part of the reward, the LLM may map task descriptions into bonuses (B) and penalties (N) so that:

$$R = I + {\sum }_{i = 1}^{n} {a}_{i} * {B}_{i} + {\sum }_{j = 1}^{n} {β}_{j} * {N}_{j}$$

where weights (α and β) associated with these parameters could be adjusted in an optimization loop.

Example 2 of Generated Code shows code of a global reward function using MTRL to combine a task independent and a task component, as shown by the three lines beginning with “#Total rewards” and ending with “+generated_rewards”.

### Example 2 of Generated Code

```
def compute_franka_reward(
  reset_buf: Tensor, progress_buf: Tensor, success: Tensor, actions: Tensor,
Ifinger_grasp_pos: Tensor, rfinger_grasp_pos: Tensor, object_pos: Tensor, goal_pos:
Tensor, object_2_init: float, object_dist_reward_scale: float, lift_bonus_reward_scale:
float, goal_dist_reward_scale: float, goal_bonus_reward_scale: float,
action_penalty_scale: float, contact_forces: Tensor, arm_inds: Tensor,
max_episode_length: int
) −> Tuple[Tensor, Tensor, Tensor]:
  # og_d: The distance between the object pose and the goal pose
  og_d = compute_object_to_goal_distance( object_pos, goal_pos)
  #object_above: Boolean, true if the object is above the table, false otherwise.
  object_above = is_object_above_initial_pose (object_pos, object_z_init)
  #Part of the reward that is task invariant
  static_rewards, reset_buf, Ifo_dist_reward = compute_franka_reward_static(
reset_buf, progress_buf, successes, actions, Ifinger_grasp_pos, rfinger_grasp_pos,
object_pos, object_z_init, object_dist_reward_scale, lift_bonus_reward_scale,
goal_dist_reward_scale, goal_bonus_reward_scale, action_penalty_scale,
contact_forces, arm_inds, max_episode_length)
  #Part of the reward that depends on the specifications provided in the task
definition
  # og_d: The distance between the object pose and the goal pose
  og_d = compute_object_to_goal_distance( object_pos, goal_pos)
  # object_above: Boolean, true if the object is above the table, false otherwise.
  object_above = is_object_above_initial_pose (object_pos, object_z_init)
  #compute generated part of the reward
  generated_rewards = compute_franka_reward_generated( Ifo_dist_reward,
object_above, og_d, goal_dist_reward_scale, goal_bonus_reward_scale)
  # Total reward
  rewards = static_rewards \
    + generated_rewards
  #Goal reached
  successes = compute_successes(og_d, successes)
  return rewards, successes
```

Example 3 of Generated Code using MTRL shows code of the task independent reward component.

### Example 3 of Generated Code

```
def compute_franka_reward_static(
  reset buf: Tensor, progress_buf: Tensor, successes: Tensor, actions: Tensor,
Ifinger_grasp_pos: Tensor, rfinger_grasp_pos: Tensor, object_pos: Tensor, goal_pos:
Tensor, object_z_init: float, object_dist_reward scale: float, lift_bonus_reward_scale:
float, goal_dist_reward_scale: float, goal_bonus_reward_scale: float,
action_penalty_scale: float, contact_forces: Tensor, arm_inds: Tensor,
max_episode_length: int
) −> Tuple[Tensor, Tensor, float]:
  # Left finger to object distance
  Ifo_d = torch.norm(object_pos − Ifinger_grasp_pos, p=2, dim =−1)
  Ifo_d = torch.clamp(Ifo_d, min=0.02)
  Ifo_dist_reward = 1.0 / (0.04 + Ifo_d)
  # Right finger to object distance
  rfo_d = torch.norm(object_pos − rfinger_grasp_pos, p=2, dim =−1)
  rfo_d = torch.clamp(rfo_d, min=0.02)
  rfo_dist_reward = 1.0 / (0.04 + rfo_d)
  # Object above table
  object_above = (object_pos[:, 2] − object_z_init) > 0.015)
  # Above the table bonus
  lift_bonus_reward = torch.zeros_like(Ifo_dist_reward)
  lift_bonus_reward = torch.where(object_above, lift_bonus_reward + 0.5,
lift_bonus_reward)
  # Regularization on the actions
  action_penalty = torch.sum(actions ** 2, dim =−1)
  # Total reward
  rewards = object_dist_reward_scale * Ifo_dist_reward +
object_dist_reward_scale * rfo_dist_reward + lift_bonus_reward_scale *
lift_bonus_reward − action_penalty_scale * action_penalty
  # Object below table height
  object_below = (object_z_init − object_pos[:, 2]) > 0.04
  reset_buf = torch.where(object_below, torch.ones_like(reset_buf), reset_buf)
  # Arm collision
  arm_collisions = torch.any(torch.norm(contact_forces[:, arm_inds, :], dim=2) >
1.0, dim=1)
  reset_buf = torch.where(arm_collisions, torch.ones_like(reset_buf), reset_buf)
  # Max episode length exceeded
  reset_buf = torch.where(progress_buf >= max_episode_length − 1,
torch.ones_like(reset_buf), reset_buf)
return rewards, reset_buf, Ifo_dist_reward
```

Example 2 Prompt shows a prompt using MTRL to request the generation of a task dependent part of a reward function.

### Example 2 Prompt

Context: We are developing in python a reward function for a Franka_move task in Isaac_gym. This function returns a tuple composed of the reward for achieving the objective. The objective is the following table top rearrangement task: “Take the cube and put it close to the robot arm.”
This reward is composed of the object to goal reward and the bonus if object is near the goal
Complete this function, setting reward function to optimize the distance between the object and its goal pose.

```
import torch
from torch import Tensor
from typing import Tuple
from gpt.utils import *
from envs.utils.torch_jit_utils import *
@torch.jit.script
Def comput_franka_reward_generated(
  Ifo_dist_reward: float,
  object_above: bool,
  og_d: float,
  goal_dist_reward_scale: float,
  goal_bonus_reward_scale: float
) −> Tuple[Tensor]:
  ”””
  Compute the reward signal for a Franka Move task in Isaac Gym.
  Args:
    Ifo_dist_reward: The reward for moving the left finger closer to the object.
    object_above: Boolean, true if the object is above the table, false otherwise.
    og_d: The distance between the object pose and the goal pose
    goal_dist_reward_scale: Scaling factor for the goal distance reward.
    goal_bonus_reward_scale: Scaling factor for the goal bonus reward.
  Returns:
    A tuple containing:
      - Rewards: The reward signal for the current state
  ”””
  # Add the code for completing the part of the reward related to optimizing the
distance between the object and its goal pose
  return rewards
```

Example 4 of Generated Code shows code generated using MTRL by LARG² for the task dependent part of a reward function.

### Example 4 of Generated Code

```
import torch
from torch import Tensor
from typing import Tuple
def compute_franka_reward_generated(
  Ifo_dist_reward: float, object_pos: Tensor, og_d: Tensor,
  object_z_init: float,
  goal_dist_reward_scale: float, goal_bonus_reward_scale: float
) −> Tuple[Tensor, float]:
  # Object above table
  object_above = (object_pos[:, 2] − object_z_init) > 0.015
  # Object to goal reward
  og_dist_reward = torch.zeros_like(Ifo_dist_reward)
  og_dist_reward = torch.where(object_above, 1.0 / (0.04 + og_d),
og_dist_reward)
  # Bonus if object is near the goal
  og_bonus_reward = torch.zeros_like(og_dist_reward)
  og_bonus_reward = torch.where(og_d <= 0.04, og_bonus_reward + 0.5,
og_bonus_reward)
  # Total reward
  rewards = goal_dist_reward_scale * og_dist_reward + goal_bonus_reward_scale
* og_bonus_reward
  return rewards
```

In one embodiment, once function code is generated, an additional validation step can occur. LLMs can be used to generate a functional test prior to starting the training process or running the task. This prompt, shown as Example 3 Prompt, may be composed of 1) a header requesting the LLM to generate a functional test, 2) a list of guidelines to condition the test, and 3) the code of the generated function. An example of a generated test is shown in Example 5 of Generated Code. Example 3 Prompt below shows a prompt requesting the generation of a functional test for a reward function.

### Example 3 Prompt

We are implementing a reward function of a custom task for a Franka Move environment within Isaac gym. Our setting is: a table holding one Franka Emika robot arm and 3 cubes of edge 5 cm.
The dimensions of the table are: (1 m×1 m×0.78 m).
The robot base position is in the middle of one of the table's sides at the 3D coordinates (0.5, 0.165, 0.78 m).
There is a gripper at the very end of the robot arm.
Our custom task is: “Move a cube to the top right corner of the table.”
Update the following python script with a functional test for the reward function “compute_franka_reward”
Reward tests should only validate cases when they should be positive (>=0) or negative (<=0).
Success should be tested against 1 or 0 values.
Def compute_franka_reward(object_pos: Tensor, Ifinger_grasp_pos: Tensor, rfinger_grasp_pos: Tensor)→Tuple[Tensor, Tensor]:
“““Our setting is: a table, a one arm robot, and 3 cubes of edge 5 cm.”””

Example 5 of Generated Code below shows a generated functional test from Example 3 Prompt.

### Example 5 of Generated Code

```
# Functional tests for the compute_franka_reward function
def test_compute_franka_reward( ):
  # Test case 1: Object positions at target position, gripper positions at target
position
  object_pos = torch.tensor([[[0.95, 0.95, 0.15], [0.9, 0.9, 0.15], [0.8, 0.8, 0.15]]])
  Ifinger_grasp_pos = torch.tensor([[[0.95, 0.95, 0.15]])
  rfinger_grasp_pos = torch.tensor([[0.95, 0.95, 0.15]])
  expected_rewards = torch.tensor([[0.0, 0.0, 0.0]])
  expected_successes = torch.tensor([[1.0, 1.0, 1.0]])
  rewards, successes = compute_franka_reward(object_pos, Ifinger_grasp_pos,
rfinger_grasp_pos)
  assert torch.allclose(rewards, expected_rewards)
  assert torch.allclose(successes, expected_successes)
  # Test case 2: Object positions far from target position, gripper positions far from
target position
  object_pos = torch.tensor([[[0.5, 0.5, 0.15], [0.6, 0.6, 0.15], [0.7, 0.7, 0.15]]])
  Ifinger_grasp_pos = torch.tensor([[[0.5, 0.5, 0.15]])
  rfinger_grasp_pos = torch.tensor([[0.5, 0.5, 0.15]])
  expected_rewards = torch.tensor([[−0.4871, −0.5831, −0.7031]])
  expected_successes = torch.tensor([[0.0, 0.0, 0.0]])
  rewards, successes = compute_franka_reward(object_pos, Ifinger_grasp_pos,
rfinger_grasp_pos)
  assert torch.allclose(rewards, expected_rewards)
  assert torch.allclose(successes, expected_successes)
  # Test case 3: Object positions close to target position, gripper positions close to
target position
  object_pos = torch.tensor([[[0.95, 0.95, 0.25], [0.9, 0.9, 0.25], [0.8, 0.8, 0.25]]])
  Ifinger_grasp_pos = torch.tensor([[[0.95, 0.95, 0.25]])
  rfinger_grasp_pos = torch.tensor([[0.95, 0.95, 0.25]])
  expected_rewards = torch.tensor([[0.15, 0.15, 0.15]])
  expected_successes = torch.tensor([[1.0, 1.0, 1.0]])
  rewards, successes = compute_franka_reward(object_pos, Ifinger_grasp_pos,
rfinger_grasp_pos)
  assert torch.allclose(rewards, expected_rewards)
  assert torch.allclose(successes, expected_successes)
print(“All tests passed!”)
```

In various examples, LARG² may be evaluated and/or used on a series of tabletop object manipulation tasks for both GCRL and MTRL settings. In a particular example, the evaluation may leverage the Franka_Move environment available on the Isaac_Gym repository. This environment describes a table, a Franka Emika Panda robot arm which is open kinematic chain composed with 7 degrees of freedom (DoF) and n cubes on the table. The dimensions of the table are as follows: 1 m×1 m×0.78 m. The robot arm is placed on the table at (0.5, 0.165, 0.78). There is a gripper with two fingers attached at the end of the arm. Cubes with a 5 cm edge are located on the surface of the table. The global origin (0,0,0) is located on the floor below the table. Each environment description is written using the Python language.

Several LLMs may be evaluated and/or used, including, but not limited to: text-davinci-003, code-davinci-002, HyperClovaX (HC), gpt-3.5-turbo and GPT4 from OpenAI, which are evolutions from GPT3 optimized with Reinforcement Learning from Human Feedback. Other LLMs that may be used include, but are not limited to, BERT, Claude, Cohere, Ernie, Falcon 40B, Galactica, Lamda, Llama, Orca, Palm, Phi-1, StableLM, and/or Vicuna 33B.

StarCoder from HuggingFace may also be used to generate goal functions over the list task defined for the GCRL example. Use of LLMs to generate goal positions and/or reward functions may involve incrementally adding prompt guidelines, incrementally testing results, and incrementally addressing issues (for example, by adding additional prompt guidelines) until the results are consistently valid for a given use case. Issues with goal positions may be related to incorrect variable initialization, missing code, and a lack of compliance with provided guidelines, such as shown in Example 6 of Generated Code and Example 7 of Generated Code below. Example 6 of Generated Code shows code generated by gpt-3.5-turbo for the task: Move a cube in the top right corner of the table.

### Example 6 of Generated Code

```
import torch
from torch import Tensor
from typing import Tuple
def generate_goal_pose( ) −> Tensor:
  ”””This function returns an eligible goal pose satisfying the following table top
rearrangement task: “move a cube in the top right corner of the table.”
  The setup is 1 table of dimension 0.81 x 1 x 0.795 on which stands 1 cube of
edge 5 cm and having its origin in its center
  The global origin (0,0,0) is located on the floor below the middle of one of the
table's sides.
  X coordinates range: (0., +0.70) = (Bottom, Top)
  Y coordinates range: (−0.4, +0.4) = (Right, Left)
  The minimum Z value for objects located on the surface of the table is 0.795 +
0.05/2 = 0.82
  Returns:
  - Tensor: a tensor of shape (3) representing the goal position
  ”””
  x = 0.65
  y = −0.35
  z = 0.82
  goal_pose = torch.tensor([x, y, z])
  return goal_pose
```

Example 7 of Generated Code shows code generated by StarCoder for the task: Move a cube in the top right corner of the table. In this example, the generated code cannot be applied, and the generated code would be detected as invalid. The LLM to use for a given process may be selected by testing the example prompts for a task such as those provided herein, and using the LLM that generates valid and useable results.

### Example 6 of Generated Code

```
import random
import numpy as np
import torch
def generate_goal_pose( ):
  # Define limits based on your environment dimensions
  max_x = &lt;max-value-for-x&gt;
  min_x = &lt;min-value-for-x&gt;
  max_y = &lt;max-value-for-y&gt;
  min_y = &lt;min-value-for-y&gt;
  max_z = &lt;max-value-for-z&gt;
  min_z = &lt;min-value-for-z&gt;
  while True:
    # Generate random values within defined ranges
    rand_vals = [random.uniform(mix_x, max_x),
      random.uniform(min_y, max_y),
      random.uniform(min_z, max_z)]
    if check_valid(*rand_vals):
      break
  return torch.tensor([*rand_vals])
def check_valid(x, y, z):
  # Check validity conditions here, e.g.:
  # Does not collide with other objects?
  # Is within workspace boundaries?
  Pass
If _—name_— == “_—main_—”:
  Print(“Example usage:”)
  pos = generate_goal_pose( ).numpy( )
  print(f”Generated Position: {pos}”)
```

In an example GCRL embodiment, the policy takes as input the position and velocity of each joint of the robot and the respective pose of the objects composing the scene. The policy triggers joint displacement in a [symbol] ⁷ action space. In addition to the position of the object composing the scene, the policy takes as input the goal positions. These positions are provided by goal functions generated by LARG². The policy may be trained beforehand using Proximal Policy Optimization with example default Franka Move parameters as defined in Table 1. The policy takes as input the position and velocity of each joint of the robot and the respective pose of the objects composing the scene. The policy triggers joint displacement in a [symbol] ⁷ action space. The goal generated may be used as additional input to the policy.

TABLE 1
Example list of parameters used in
the Franka Move PPO training loop

| training parameters | values |
|---|---|
| number of environments | 2048 |
| episode length | 500 |
| object distance reward scale | 0.08 |
| lift bonus reward scale | 4.0 |
| goal distance reward scale | 1.28 |
| goal bonus reward scale | 4.0 |
| action penalty scale | 0.0 |
| collision penalty scale | 1.28 |
| actor hidden dimension | [256, 128, 64] |
| critic hidden dimension | [256, 128, 64] |

Goal generation may be performed for an initial set of 32 tasks, including 27 tasks that involve a single object and 5 tasks that encompass three objects. Tasks labeled d17 to d27 in Table 2 below may be characterized by objectives defined in relation to the initial positions of the objects. In this case, the signature of the goal function may take as input the initial position of the cubes composing the scene. Example 4 Prompts shows a prompting workflow which translates a task description into the generation of a goal function. The prompting workflow involves an auto-correction step and the production of a functional test afterwards.

FIG. 14A illustrates example results produced by 10 example runs of 3 different goal poses generated for 3 different manipulation tasks: (1420) Put the object at 15 cm above the table, (1422) Put the object at the lefthand side of the table, and (1424) Put the object at the righthand side of the table. The resulting poses were well aligned with task requirements while exploring the range of valid positions allowed by a non-deterministic task definition.

Table 2 provides the list of tasks used in various examples and reports the example compliance of generated goals with task descriptions. Tasks d17 to d27 involve objectives related to the object's initial position. Tasks d28 to d32 address 3 object manipulation problems and therefore 3 goals. Localization compliance with task definition is reported.

TABLE 2
list of 32 example manipulation tasks evaluated with LARG²

| | | Gener- |
|---|---|---|
| | | ated |
| | | Pose |
| ID | Task | Validity |
| d01 | Move a cube to the top right corner of the table. | ✓ |
| d02 | Move a cube to the top left corner of the table. | ✓ |
| d03 | Move a cube to the bottom right corner of the table. | ✓ |
| d04 | Move a cube to the bottom left corner of the table. | ✓ |
| d05 | Lift the cube 15 cm above the table. | ✓ |
| d06 | Rotate a cube upside-down. | ✓ |
| d07 | Take to cube and move it to the left side of the table. | — |
| d08 | Take to cube and move it to the right edge of the table. | ✓ |
| d09 | Take to cube and raise it at 20 cm to the far side of | ✓ |
| | the table. | |
| d10 | Take the cube and move it closer to the robotic arm. | ✓ |
| d11 | Pick up the cube and move it away from the robotic arm. | ✓ |
| d12 | Take the cube and move it very close to the robotic arm. | — |
| d13 | Push the cube off the limits of the table. | ✓ |
| d14 | Bring the cube closer to the robot arm. | ✓ |
| d15 | Move the cube to one corner of the table. | ✓ |
| d16 | Place the cube anywhere on the diagonal of the table | ✓ |
| | running from the top right corner to the bottom | |
| | left corner. | |
| d17 | Lift the cube 15 cm above the table and 10 cm to the | ✓ |
| | right. | |
| d18 | Lift the cube 20 cm above the table and 15 cm ahead. | ✓ |
| d19 | Lift the cube 20 cm above the table and 15 cm backward. | ✓ |
| d20 | Push a cube 10 cm to the right and 10 cm ahead. | ✓ |
| d21 | Push a cube 10 cm to the right and 10 cm backward. | ✓ |
| d22 | Push a cube 10 cm to the left and 10 cm ahead. | ✓ |
| d23 | Push a cube 10 cm to the left and 10 cm backward | ✓ |
| d24 | Grab a cube and move it a bit to the left. | ✓ |
| d25 | Grab a cube and lift it a bit and move it a bit ahead. | ✓ |
| d26 | Move the cube at 20 cm to the left of its initial position. | ✓ |
| d27 | Move the cube 20 cm above its current position. | ✓ |
| d28 | Move one cube to the left side of the table, another one | ✓ |
| | to the right side of the table, and put the last | |
| | cube at the center of the table. | |
| d29 | Move the three cubes so they are 10 cm close to one | ✓ |
| | another. | |
| d30 | Move the three cubes on the table so that at the end | ✓ |
| | they form a right-angled triangle. | |
| d31 | Move the three cubes on the table so that at the end | ✓ |
| | they form an isosceles triangle. | |
| d32 | Reposition the three cubes on the table such that | ✓ |
| | they create a square, with the table's center | |
| | serving as one of the square's corners. | |

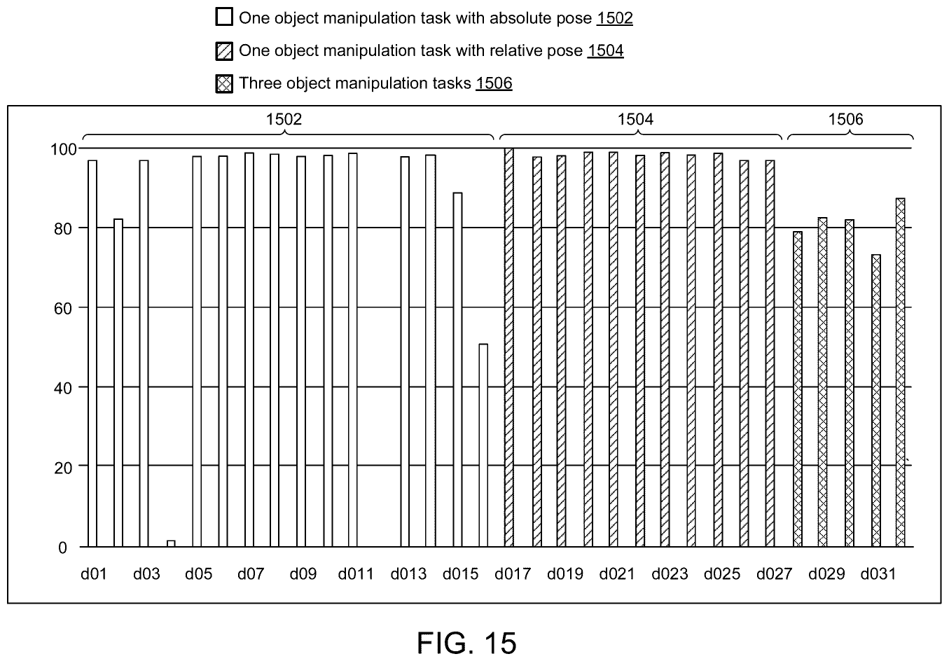

FIG. 15 shows example success rates for an example set of 32 manipulation tasks, with example success rates marked for one object manipulation task with an absolute pose 1502, one object manipulation task with a relative pose 1504, and three object manipulation tasks 1506. When examining unsuccessful experiments, a source of error may, in some examples, be traced back to insufficient contextual information and constraints within the task definition. There are at least two options to address this issue: firstly, enhancing the prompt with more constraints, and secondly, opting for a more capable Large Language Model (LLM) with respect to code generation capabilities.

This example underscores the reasoning capabilities of the Large Language Model (LLM), as depicted in Example 7 of Generated Code. In this specific task, the overall task is to lift a cube to a height of 15 cm above the table. The generated goal function demonstrates the ability to correctly calculate the target position by adding the table's height to the specified 15 cm.

LARG² allows to generate code for goal prediction according to textual task descriptions. In some cases, the generated code does not properly fit with user specifications, but the example demonstrates that a feedback loop with additional guidelines can fix invalid code.

Example 4 Prompts shows prompts illustrating three steps involved in an example generation of a valid goal positioning function: 1) request to generate a function according to specific environment parameters, 2) auto-correction, 3) final validation. The three lines beginning with “‘AssertionError:” contain the error message generated at the execution phase.

### Example 4 Prompts

### First Prompt in Example 4 Prompts

We are implementing a table top rearrangement task within Isaac gym.
We need to set goal positions.
Could you complete the code of the python function “generate_goal_pose” below with its body implementation according to settings defined in the docstring below for the goal:
“Move the three cubes on the table so at the end they form a right-angled triangle.”

### Code to be Completed:

```
import torch
from torch import Tensor
from typing import Tuple
def generate_goal_pose( ) −> Tuple[Tensor]:
  ″″″This function returns an eligible goal pose satisfying the following tablet op
rearrangement task: “nest a cube in the top right corner of the table”
  The setup is 1 table of dimension 0.81 x 1 x 0.795 on which stands 1 cube of
edge 5cm and having its origin in its center.
  The global origin (0,0,0) is located on the floor below the middle of one of the
table's sides.
  X coordinates range: (0., 0.70)
  Y coordinates range: (−0.4, 0.4)
  The minimum Z value for objects located on the surface of the table is 0.795 +
0.05/2 = 0.82
  Returns :
  - Tensor: a tensor of shape (3) representing the goal position
  ″″″
```

It is important to leave the function signature unchanged and keep the docstring as is.
Do not generate sample usage nor inner functions.
Double-check for any unused variables or functions, missing or incorrect imports, punctuation marks, indentation errors, or mismatched parentheses/brackets.

### Second Prompt in Example 4 Prompts

Could you please fix the error:
‘AssertionError: <function generate_goal_pose at 0x7f4bec4bf550> should return one element of shape 3: (tensor([0.5821, 0.1927, 0.8200]),)’
in the following function implementation:

```
import torch
from torch import Tensor
from typing import Tuple
import random
def generate_goal_pose( ) −> Tuple[Tensor]:
  ″″″
  This function returns an eligible goal pose satisfying the following tabletop
rearrangement task: “nest a cube in the top right corner of the table.”
  The setup is 1 table of dimension 0.81 x 1 x 0.795 on which stands 1 cube of
edge 5cm and having its origin in its center.
  The global origin (0, 0, 0) is located on the floor below the middle of one of the
table's sides.
  X coordinates range: (0., 0.70)
  Y coordinates range: (−0.4, 0.4)
  The minimum Z value for objects located on the surface of the table is 0.795 +
0.05/2 = 0.82
  Returns:
    - Tensor: a tensor of shape (3) representing the goal position
  ″″″
  x = random.uniform(0, 0.7)
  y = random.uniform(0, 0.4)
  z = 0.82
  return (torch.tensor([x, y, z]),)
```

### Third Prompt in Example 4 Prompts

Update the following python script with functional tests for the goal position function “generate_goal_pose”.
Do not add any explanation text.
Return the same script plus what you have inserted.

```
# Functional Tests
def test_generate_goal_pose( ):
  print(″starting functional tests”)
  #
  # insert the functional tests here
  #
```

FIG. 14A shows an example of goal positions generated by an example method described herein for 3 different tasks requesting targets to be located on the right, left, and above the table.

FIG. 15 shows example success rates for GCRL manipulation tasks. In the example shown, d01-d16 reflect 1 object manipulation for absolute pose whereas d17-d27 reflect relative object pose. D28-d32 relates to 3 object manipulation tasks.

Example 7 of Generated Code shows arithmetic capabilities of the LLM for Task d05. The comment starting with “#Add 15 cm” as well as the related code starting with target_z is generated by the LLM.

### Example 7 of Generated Code

```
import torch
from torch import Tensor
from typing import Tuple
def generate_goal_pose( ) −> Tensor:
  # Define the minimum and maximum allowed positions
  min_x, max_x = 0.0, 0.7
  min_y, max_y = −0.4, 0.4
  min_z = 0.82
  target_z = min_z + 0.15 # Add 15 cm to the minimum Z value
  # Generate random X and Y coordinates within the allowed ranges
  x = torch.rand(1) * (max_x − min_x) + min_x
  y = torch.rand(1) * (max_y − min_y) + min_y
  # Create a tensor with the goal position
  goal_position = torch.tensor([x, y, target_z])
  return goal_position
```

A second example evaluates and/or uses LARG2 capability to address MTRL settings. For task encoding, the second example uses the Google T5-small language model. The second example uses the [CLS] token embedding computed by the encoder stack of the model which is defined in [symbol] ⁵¹² and feeds it into a fully connected network stack used as policy. Before feeding into the network stack, the token embedding may be concatenated with state information from the manipulation environment which may be, for example, defined in [symbol] ⁷. The state information may include, for example, information about the dimensions and/or position of the autonomous machine, the object(s) in the environment, environment boundaries, and/or environment topography. The resulting policy is composed of three layers using respectively, {512, 128, 64} hidden dimensions.

In this example, MTRL settings are trained using Proximal Policy Optimization (PPO) with default Franka Move parameters using reward functions generated by LARG² over 9 tasks listed below in Table 3. These tasks address one object manipulation on a tabletop. The example leverages the LLM capabilities to paraphrase these tasks to produce the evaluation set. Paraphrases include task translation as the Google T5 model is trained for downstream tasks such as machine translation.

In one example, the application of Task m04 may be submitted as a text based command in Korean language “ [symbol] [symbol] 20 cm [symbol] .”) to a policy trained in MTRL. In various embodiments, the system described herein employs multi-lingual capabilities for robot manipulation. Example tasks are submitted using different languages including English, Arabic and Korean, and translated into corresponding robot movements through robot training using the goal position(s) and/or reward function.

TABLE 3
List of example tasks used in the MTRL settings

| ID | Task |
|---|---|
| m01 | Push the cube to the far right of the table. |
| m02 | Move a cube to the top left corner of the table. |
| m03 | Take the cube and put it close to the robot arm. |
| m04 | Move a cube at 20 cm above the center of the table. |
| m05 | Move a cube at 15 cm above the table |
| m06 | Take the cube and put it on the diagonal of the table. |
| m07 | Push the cube at 20 cm ahead of its current position. |
| m08 | Move the cube to the center of the table. |
| m09 | Grab the cube and move it forward to the left. |

FIG. 16 provides example success rates obtained for the 9 tasks used in the MTRL examples over automatic reward generation. It illustrates LARG² capabilities to generate valid reward functions to train and execute MTRL policies conditioned by textual task definitions.

Provided herein are several additional examples of code generated by LARG² using techniques described herein. Additional examples include:
Example 8 of Generated Code corresponding to Task d08,
Example 9 of Generated Code corresponding to Task d12,
Example 10 of Generated Code corresponding to Task d15,
Example 11 of Generated Code corresponding to Task d16,
Example 12 of Generated Code corresponding to Task d17,
Example 13 of Generated Code corresponding to Task d19,
Example 14 of Generated Code corresponding to Task d25,
Example 15 of Generated Code corresponding to Task d26,
Example 16 of Generated Code corresponding to Task d29, and
Example 17 of Generated Code corresponding to Task d30.

### Example 8 of Generated Code Corresponding to Task d08: Take the Cube and Move it to the Right Edge of the Table.

```
import torch
from torch import Tensor
from typing import Tuple
def generate_goal_pose( ) −> Tensor:
  “””This function returns an eligible goal pose satisfying the following table top
rearrangement task: “can you take the cube and move it to the right edge of the table.”
  The setup is 1 table of dimension 0.81 x 1 x 0.795 on which stands 1 cube of
edge 5cm and having its origin in its center.
  The global origin (0,0,0) is located on the floor below the middle of one of the
table's sides.
  X coordinates range: (0., +0.70) = (Bottom, Top)
  Y coordinates range: (−0.4, +0.4) = (Right, Left)
  The minimum Z value for objects located on the surface of the table is 0.795 +
0.05/2 = 0.82
  Returns:
  - Tensor: a tensor of shape (3) representing the goal position
  “””
  # The goal position will be at the right edge of the table, so we can set the y-
coordinate to the maximum value of the range
  goal_pose = torch.tensor([0.35, 0.4, 0.82])
  return goal_pose
```

### Example 9 of Generated Code Corresponding to Task d12: Take the Cube and Move it Very Close to the Robotic Arm.

```
import torch
from torch import Tensor
from typing import Tuple
def generate_goal_pose( ) −> Tensor:
  “””This function returns an eligible goal pose satisfying the following table top
rearrangement task: “take the cube and move it very close to the robotic arm.”
  The setup is 1 table of dimension 0.81 x 1 x 0.795 on which stands 1 cube of
edge 5cm and having its origin in its center.
  The global origin (0,0,0) is located on the floor below the middle of one of the
table's sides.
  X coordinates range: (0., +0.70) = (Bottom, Top)
  Y coordinates range: (−0.4, +0.4) = (Right, Left)
  The minimum Z value for objects located on the surface of the table is 0.795 +
0.05/2 = 0.82
  Returns:
  - Tensor: a tensor of shape (3) representing the goal position
  “””
  # move the cube very close to the robotic arm (at y=−0.35) and 5cm above the
table surface
  goal_position = torch.tensor([0.6, −0.35, 0.82])
  return goal_position
```

### Example 10 of Generated Code Corresponding to Task d15: Move the Cube to One Corner of the Table.

```
import torch
from torch import Tensor
from typing import Tuple
def generate_goal_pose( ) −> Tensor:
  “””This function returns an eligible goal pose satisfying the following table top
rearrangement task: “move the cube to one corner of the table.”
  The setup is 1 table of dimension 0.81 x 1 x 0.795 on which stands 1 cube of
edge 5cm and having its origin in its center.
  The global origin (0,0,0) is located on the floor below the middle of one of the
table's sides.
  X coordinates range: (0., +0.70) = (Bottom, Top)
  Y coordinates range: (−0.4, +0.4) = (Right, Left)
  The minimum Z value for objects located on the surface of the table is 0.795 +
0.05/2 = 0.82
  Returns:
  - Tensor: a tensor of shape (3) representing the goal position
  “””
  goal_pose = torch.tensor([0.7, −0.4, 0.82])
  return goal_pose
```

Example 11 of Generated Code Corresponding to Task d16: Place the Cube Anywhere on the Diagonal of the Table Running from the Top Right Corner to the Bottom Left Corner.

```
import torch
from torch import Tensor
from typing import Tuple
def generate_goal_pose( ) −> Tensor:
  “””This function returns an eligible goal pose satisfying the following table top
rearrangement task: “place the cube anywhere on the diagonal of the table running from
the top right corner to the bottom left corner.”
  The setup is 1 table of dimension 0.81 x 1 x 0.795 on which stands 1 cube of
edge 5cm and having its origin in its center.
  The global origin (0,0,0) is located on the floor below the middle of one of the
table's sides.
  X coordinates range: (0., +0.70) = (Bottom, Top)
  Y coordinates range: (−0.4, +0.4) = (Right, Left)
  The minimum Z value for objects located on the surface of the table is 0.795 +
0.05/2 = 0.82
  Args:
  - cube: a tensor of shape (3) representing the cube position on the table
  Returns:
  - Tensor: a tensor of shape (3) representing the goal position on the table
  “””
  goal_x = torch.tensor([0.7]).to(cube.device)
  goal_y = torch.tensor(−[0.4]).to(cube.device)
  goal_z = torch.tensor([0.82]).to(cube.device)
  # calculate the slope of the diagonal line
  slope = −(goal_y / goal_x)
  # calculate the y intercept of the diagonal line
  Y_int = goal_y − (slope * goal_x)
  # use the slope and y intercept to calculate the desired y position of the cube
  goal_y_cub = (slope + cube[0]) + y_int
  # create the goal pose tensor
  goal_pose = torch.tensor([cube[0], goal_y−cub, goal_z]).to(cube.device)
  return goal_pose
```

### Example 12 of Generated Code Corresponding to Task d17: Lift the Cube 15 cm Above the Table and 10 cm to the Right.

```
import torch
from torch import Tensor
from typing import Tuple
def generate_goal_pose( ) −> Tensor:
  “””This function returns an eligible goal pose satisfying the following table top
rearrangement task: “lift the cube 15cm above the table and 10 cm to the right.”
  The setup is 1 table of dimension 0.81 x 1 x 0.795 on which stands 1 cube of
edge 5cm and having its origin in its center.
  The global origin (0,0,0) is located on the floor below the middle of one of the
table's sides.
  X coordinates range: (0., +0.70) = (Bottom, Top)
  Y coordinates range: (−0.4, +0.4) = (Right, Left)
  The minimum Z value for objects located on the surface of the table is 0.795 +
0.05/2 = 0.82
  Returns:
  - Tensor: a tensor of shape (3) representing the goal position
  “””
  goal_pose = torch.tensor([0.35, 0.1, 0.82+0.15])
  return goal_pose
```

### Example 13 of Generated Code Corresponding to Task d19: Lift the Cube 20 cm Above the Table and 15 cm Backward.

```
import torch
from torch import Tensor
from typing import Tuple
def generate_goal_pose( ) −> Tensor:
  “””This function returns an eligible goal pose satisfying the following table top
rearrangement task: “lift the cube 20cm above the table and 15 cm backward.”
  The setup is 1 table of dimension 0.81 x 1 x 0.795 on which stands 1 cube of
edge 5cm and having its origin in its center.
  The global origin (0,0,0) is located on the floor below the middle of one of the
table's sides.
  X coordinates range: (0., +0.70) = (Bottom, Top)
  Y coordinates range: (−0.4, +0.4) = (Right, Left)
  The minimum Z value for objects located on the surface of the table is 0.795 +
0.05/2 = 0.82
  Returns:
  - Tensor: a tensor of shape (3) representing the goal position
  “””
  # We need to lift the cube vertically by 20 cm and move it back by 15 cm
  x_pos = 0.7
  y_pos = −0.15
  z_pos = 0.82 + 0.05
  goal_pose = torch.tensor([x_pos, y_pos, z_pos])
  return goal_pose
```

### Example 14 of Generated Code Corresponding to Task d25: Grab a Cube and Lift it a Bit and Move it a Bit Ahead.

```
import torch
from torch import Tensor
from typing import Tuple
def generate_goal_pose( ) −> Tensor:
  “””This function returns an eligible goal pose satisfying the following table top
rearrangement task: “move the cube to one corner of the table.”
  The setup is 1 table of dimension 0.81 x 1 x 0.795 on which stands 1 cube of
edge 5cm and having its origin in its center.
  The global origin (0,0,0) is located on the floor below the middle of one of the
table's sides.
  X coordinates range: (0., +0.70) = (Bottom, Top)
  Y coordinates range: (−0.4, +0.4) = (Right, Left)
  The minimum Z value for objects located on the surface of the table is 0.795 +
0.05/2 = 0.82
  Returns:
  - Tensor: a tensor of shape (3) representing the goal position
  “””
  goal_pose = torch.tensor([0.7, −0.4, 0.82])
  return goal_pose
```

### Example 15 of Generated Code Corresponding to Task d26: Move the Cube at 20 Cm to the Left of its Initial Position.

```
import torch
from torch import Tensor
from typing import Tuple
def generate_goal_pose( ) −> Tensor:
  “””This function returns an eligible goal pose satisfying the following table top
rearrangement task: “move the cube at 20 cm to the left of its initial position.”
  The setup is 1 table of dimension 0.81 x 1 x 0.795 on which stands 1 cube of
edge 5cm and having its origin in its center.
  The global origin (0,0,0) is located on the floor below the middle of one of the
table's sides.
  X coordinates range: (0., +0.70) = (Bottom, Top)
  Y coordinates range: (−0.4, +0.4) = (Right, Left)
  The minimum Z value for objects located on the surface of the table is 0.795 +
0.05/2 = 0.82
  Args:
  - Tensor: a tensor of shape (3) representing the cube position on the table
  Returns:
  - Tensor: a tensor of shape (3) representing the goal position on the table
  “””
  # Calculate the goal position by moving 20cm to the left of the initial position
  goal_position = torch.tensor([0.2, cube[1] − 0.2, 0.82])
  return goal_position
```

Example 16 of Generated Code Corresponding to Task d29: Rearrange Three Cubes in Such a Way that the Distance Between Each of them is 10 Centimeters.

```
import torch
from torch import Tensor
from typing import Tuple
def generate_relative_goal_poses(cube1: Tensor, cube2: Tensor, cube3: Tensor) −>
Tuple[Tensor, Tensor, Tensor]:
  “””This function returns a tuple of eligible goal poses satisfying the following table
top rearrangement task: “rearrange three cubes in such a way that the distance between
each of them is 10 centimeters.”
  The setup is 1 table of dimension 0.75 x 0.8 x 0.78 on which stands 3 cubes of
edge 5cm.
  Each cube has its own origin in its center.
  The global origin (0,0,0) is located on the floor below the middle of one of the
table's sides.
  X coordinates range: (0., +0.75) = (Bottom, Top)
  Y coordinates range: (−0.4, +0.4) = (Right, Left)
  The minimum Z value for objects located on the surface of the table is 0.78 +
0.05/2 = 0.805
  Args:
  - Tensor: a tensor of shape (3) representing the position of the first cube on the
table
  - Tensor: a tensor of shape (3) representing the position of the second cube on
the table
  - Tensor: a tensor of shape (3) representing the position of the third cube on the
table
  Returns: Tuple(Tensor Tensor, Tensor)
  - Tuple: a tuple of 3 tensors. Each tensor of shape (3) represents the goal position
of one cube on the table
  “””
  distance = 10 / 100 # Convert distance to meters
  if cube1[0] >= 0.5:
    cube1[0] = 0.5
  if cube1[1] >= 0.2:
    cube1[1] = 0.2
  if cube1[1] <= −0.2:
    cube1[1] = −0.2
  goal_positions = [cube1]
  for reference in [cube2, cube3]:
    found = False
    while not found:
      angle = torch.rand(1, device=reference.device) * 2 * torch.pi
      x_offset = distance * torch.cos(angle)
      y_offset = distance * torch.sin(angle)
      candidate_position = goal_positions[−1] + torch.tensor([x_offset,
y_offset, 0], device=reference.device).squeeze( )
      # Check if candidate_position is within table boundaries
      if (0 < candidate_position[0] < 0.75) and (−0.45 <
candidate_position[1] < 0.45) and candidate_position[2] >= 0.8:
        all_distances_valid = True
        for pos in goal_positions:
          dist = torch.norm(candidate_position − pos)
          if not torch.isclose(dist, torch.tensor(distance,
device=reference.device), rtol=1e−2, atol=1e−2):
              all_distances_valid = False
                break
        if all_distances_valid:
          found = True
          goal_positions.append(candidate_position)
      else:
        print(candidate_position)
  return tuple(goal_positions)
```

Example 17 of Generated Code Corresponding to Task d30: Move the Three Cubes on the Table so at the End they Form a Right-Angled Triangle with One Corner at the Center of the Table.

```
import torch
from torch import Tensor
from typing import Tuple
def generate_goal_poses( ) −> Tuple[Tensor, Tensor, Tensor]:
  “””
  This function returns an eligible goal pose satisfying the following table top
rearrangement task: “move the three cubes on the table so at the end they form a right
angled triangle with one corner at the center of the table.”
  The setup is 1 table of dimension 0.75 x 0.8 x 0.78 on which stands 3 identical
cubes of edge 5cm and each having their origins in their respective centers.
  The global origin (0,0,0) is located on the floor below the middle of one of the
table's sides.
  X coordinates range: (0., 0.75)
  Y coordinates range: (−0.4, 0.4)
  The minimum Z value for objects located on the surface of the table is 0.78 +
0.05/2 = 0.805
  Returns a tuple of Tensors:
  - [Tensor, Tensor, Tensor]: Each tensor if of shape (3) and contains a goal
position
  “””
  # Define the positions of the three cubes
  pos1 = torch.tensor([0.45, −0.25, 0.805])
  pos2 = torch.tensor([0.65, 0.25, 0.805])
  pos3 = torch.tensor([0.35, 0.25, 0.805])
  # Rotate the positions to form a right-angled triangle with one corner at the center
of the table
  angle = torch.tensor([0, 0, −45]) * (3.14159 / 180)
  rot_mat = torch.tensor([torch.cos(angle[2]), −torch.sing(angle[2]), 0],
[torch.sin(angle[2]), torch.cos(angle[2]), 0], [0, 0, 1]])
  center_pos = torch.tensor([0.375, 0, 0.805])
  pos1 = torch.matmul(rot_mat, pos1 − center_pos) + center_pos
  pos2 = torch.matmul(rot_mat, pos2 − center_pos) + center_pos
  pos3 = torch.matmul(rot_mat, pos3 − center_pos) + center_pos
  return pos1, pos2, pos3
```

### 9. General

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A computer-implemented method for training an autonomous machine to perform a target task in a target environment, comprising:
generating a prompt for a large language model at least in part by combining a natural language description of the target task and a natural language description of the target environment, wherein the prompt requests executable source code to use for training a policy for the autonomous machine to perform the target task;
generating a function by prompting the large language model with the prompt, wherein, based on the prompt, the function comprises executable source code that, when used to train the policy, causes a reward to be provided based on whether a goal position is reached in the target environment;
computing a state description using a model of the target environment, wherein the state description comprises a position of the autonomous machine relative to the target environment; and
training the policy for the autonomous machine to perform the target task using the function and the state description.

2. The computer-implemented method of claim 1, wherein the target environment includes an object other than the autonomous machine, wherein the prompt includes a description of the object, wherein the goal position is a target three-dimensional position of the object, and wherein the state description further comprises a current three-dimensional position of the object.

3. The computer-implemented method of claim 1, wherein the prompt includes a function definition with parameters, a docstring describing functionality of the parameters of the function, and a request to extend the function with a body implementation of the function.

4. The computer-implemented method of claim 1 further comprising validating the function at least in part by prompting a large language model for tests to validate the function.

5. The computer-implemented method of claim 4 further comprising correcting the function when said validating identifies an issue at least in part by prompting a large language model for a correction, wherein prompting the large language model for the correction includes providing, to the large language model, the function and information about the issue.

6. The computer-implemented method of claim 1, wherein the prompt includes one or more examples of one or more valid functions for one or more tasks other than the target task, wherein the one or more examples are provided in source code form.

7. The computer-implemented method of claim 1, wherein the prompt is a second prompt, further comprising:
generating a first prompt for a large language model at least in part by combining the natural language description of the target task and the natural language description of the target environment, wherein the first prompt requests one or more goal positions to use in training the policy for the autonomous machine to perform the target task;
generating the goal position by prompting a large language model with the first prompt;
wherein the second prompt references the goal position.

8. The computer-implemented method of claim 6, further comprising:
searching an existing code repository to find the one or more examples based at least in part on the natural language description of the target task;
wherein different examples are used to generate different functions for at least two different target tasks including said target task.

9. The computer-implemented method of claim 1, wherein the prompt includes an example of a task-independent portion of another function; wherein the task-independent portion of the other function is stored in a repository with other task-independent portions of a plurality of functions and selected based at least in part on the natural language description of the target task and one or more characteristics of the task-independent portion; wherein the prompt requests that the large language model include an explicit reference to the task-independent portion of the other function in the function.

10. The computer-implemented method of claim 1, wherein the prompt includes an example of a task-dependent portion of another function; wherein the task-dependent portion of the other function is stored in a repository with other task-dependent portions of a plurality of functions and selected based at least in part on the natural language description of the target task and one or more characteristics of the task-dependent portion; wherein the prompt requests that the large language model use the task-dependent portion as an example without including, in the function to be generated based on the prompt, the task-dependent portion of the other function and without including, in the function to be generated based on the prompt, a reference to the task-dependent portion of the other function.

11. A computer system for training an autonomous machine to perform a target task in a target environment, the computer system comprising:
one or more processors;
one or more non-transitory computer-readable media storing processor-executable instructions which, when executed, cause:
receiving a natural language description of the target task and a natural language description of the target environment;
generating a prompt for a large language model at least in part by combining the natural language description of the target task and the natural language description of the target environment, wherein the prompt requests executable source code to use for training a policy for the autonomous machine to perform the target task;
generating a function by prompting the large language model with the prompt, wherein, based on the prompt, the function comprises executable source code that, when used to train the policy, causes a reward to be provided based on whether a goal position was reached in the target environment;
computing a state description using a model of the target environment, wherein the state description comprises a position of the autonomous machine relative to the target environment; and
training the policy for the autonomous machine to perform the target task using the function and the state description.

12. The computer system of claim 11, wherein the target environment includes an object other than the autonomous machine, wherein the prompt includes a description of the object, wherein the goal position is a target three-dimensional position of the object, and wherein the state description further comprises a current three-dimensional position of the object.

13. The computer system of claim 11, wherein the prompt includes a function definition with parameters, a docstring describing functionality of the parameters of the function, and a request to extend the function with a body implementation of the function.

14. The computer system of claim 11, wherein the prompt includes one or more examples of one or more valid functions for one or more tasks other than the target task, wherein the one or more examples are provided in source code form.

15. The computer system of claim 11, wherein the prompt is a second prompt, the computer system further comprising one or more non-transitory computer-readable media storing additional processor-executable instructions which, when executed, cause:
generating a first prompt for a large language model at least in part by combining the natural language description of the target task and the natural language description of the target environment, wherein the first prompt requests one or more goal positions to use in training the policy for the autonomous machine to perform the target task;
generating the goal position by prompting a large language model with the first prompt;
wherein the second prompt references the goal position.

16. One or more non-transitory computer-readable media for training an autonomous machine to perform a target task in a target environment, the one or more non-transitory computer-readable media storing processor-executable instructions which, when executed, cause:
receiving a natural language description of the target task and a natural language description of the target environment;
generating a prompt for a large language model at least in part by combining the natural language description of the target task and the natural language description of the target environment, wherein the prompt requests executable source code to use for training a policy for the autonomous machine to perform the target task;
generating a function by prompting the large language model with the prompt, wherein, based on the prompt, the function comprises executable source code that, when used to train the policy, causes a reward to be provided based on whether a goal position was reached in the target environment;
computing a state description using a model of the target environment, wherein the state description comprises a position of the autonomous machine relative to the target environment; and
training the policy for the autonomous machine to perform the target task using the function and the state description.

17. The one or more non-transitory computer-readable media of claim 16, wherein the target environment includes an object other than the autonomous machine, wherein the prompt includes a description of the object, wherein the goal position is a target three-dimensional position of the object, and wherein the state description further comprises a current three-dimensional position of the object.

18. The one or more non-transitory computer-readable media of claim 16, wherein the prompt includes a function definition with parameters, a docstring describing functionality of the parameters of the function, and a request to extend the function with a body implementation of the function.

19. The one or more non-transitory computer-readable media of claim 16, wherein the prompt includes one or more examples of one or more valid functions for one or more tasks other than the target task, wherein the one or more examples are provided in source code form.

20. The one or more non-transitory computer-readable media of claim 16, wherein the prompt is a second prompt, wherein the processor-executable instructions, when executed, further cause:
generating a first prompt for a large language model at least in part by combining the natural language description of the target task and the natural language description of the target environment, wherein the first prompt requests one or more goal positions to use in training the policy for the autonomous machine to perform the target task;
generating the goal position by prompting a large language model with the first prompt;
wherein the second prompt references the goal position.

21. A computer-implemented method for training an autonomous machine to perform a target task in a target environment, comprising:
generating a reward signature by combining a natural language description of the target task and a natural language description of the target environment;
generating a reward function by prompting a large language model with the reward signature;
computing a state description using a model of the target environment and an embedding of the natural language task description; and
training a policy for the autonomous machine to perform the target task using the reward function and the state description.

22. A computer-implemented method for training an autonomous machine to perform a target goal in a target environment, comprising:
generating a goal position signature by combining a natural language description of the target goal and a natural language description of the target environment;
generating a goal position function by prompting a large language model with the goal position signature;
computing a state description using a model of the target environment and a goal position derived from the goal position function; and
training a policy for the autonomous machine to reach the target goal using the goal position derived from the goal position function, the state description, and the reward function.
